(19) United States
(12) Patent Application Publication
(10) Pub. No.: US 2003/0074253 A1
(43) Pub. Date: Apr. 17, 2003

(54) System and method for matching consumers with products

(76) Inventors: Sylvia Tidwell Scheuring, Carmel, CA (US); Jerome James Scheuring, Carmel, CA (US); David A. Schultz, Richmond, CA (US)

Correspondence Address: SQUIRE, SANDERS & DEMPSEY L.L.P, 600 HANSEN WAY, PALO ALTO, CA, 94304-1043, US

(21) Appl. No.: 10/066,126

(22) Filed: Jan. 30, 2002

Related U.S. Application Data
(60) Provisional application No. 60/265,260, filed on Jan. 30, 2001.

(51) Int. Cl. G06F 17/60

(52) U.S. Cl. 705/10

(57) ABSTRACT

A matching system includes consumer and product/vendor portrayer engines capable of determining, monitoring and modifying consumer and product/vendor cognitive and factual information, and a matching engine capable of determining corresponding consumer information of one or more consumers and product and/or vendor information of one or more products and/or vendors. In an exemplary embodiment, the cognitive information comprises consumer and product and/or vendor profiles including a weighted personality aspect set. The cognitive information also includes consumer and product and/or vendor intent and long-term interests, and the product information includes parameters linked to consumer fact information. The information can further be gathered from devices and/or processes of an interconnected network and the results of matching can be presented to or for a consumer via one or more devices accessible to the matching system, in accordance with one or more applications. Embodiments also provide for interfacing, reliability assurance, security and other aspects.

### CROSS-REFERENCE TO RELATED APPLICATION

This application claims the benefit under 35 U.S.C. §119(e) of U.S. Provisional Application No. 60/265,260 filed Jan. 30, 2001, entitled System and Method for Matching Consumers with Products, by Sylvia Tidwell Scheuring, Jerome James Scheuring, and David A. Schultz, which is herein incorporated by reference.

### BACKGROUND OF THE INVENTION

1. Field of the Invention

This invention relates generally to networked systems, and more particularly, to systems and methods for matching consumers and products that can be distributed over a computer network.

2. Description of the Background Art

The promise of computing has long been to facilitate the handling of information, increase user productivity and thus make users' lives somewhat easier. Several advances have also appeared. Typed commands and data have given way to current pictorial and expected virtual and augmented-reality environments supporting pointer, speech, pen-based and other interface mechanisms. Processing, memory and storage capacities have increased. The advent of the Internet, presentation tools, push/pull technologies, mobile code (e.g. Java Applets™, Microsoft ActiveX™ controls, etc.), reduced bitrate multimedia, compression, protocol/language standards (e.g. TCP/IP, hypertext markup language or “HTML”, etc.), and other advances have rendered access to vast informational resources almost commonplace.

Unfortunately, the inefficient nature and experience of using computing devices has remained essentially unchanged. Users continue to be presented with generically applicable “blank sheets of paper” (i.e. programs) having sets of functionally divided generic tools (i.e. window or window segment based menus and tool icons). A user still finds, enters, loads or points to a portion of generic factual data (e.g. document portion or web page element), selects a tool, perhaps enters some further data, and then weeds through the often unintended or otherwise less than desirable or pertinent results. Variations exist, such as: message center speech-based question and answer frames versus PC graphic windows; increased PC program tools and tool complexity versus PDA-based minimalistic approaches, etc. However, the differences tend to increase rather than relieve these and other user difficulties.

For example, a user can copy and even “dynamically link” a data block between applications, documents or certain devices; however, the user must find and select the source, block, tool and destination, and further manipulate the copy if it is to be utilized in some useful manner. A user attempting to find information can use a search tool. However, the user must typically indicate a source, select the tool; determine and enter a keyword (i.e. a word or phrase), and enter any appropriate Boolean operators; the user must then typically weed through an often long list of “word or phrase matched” data that bares little resemblance to the information to which the search was directed. An electronic calendar user is similarly faced with reviewing an often extensive collection of unrelated appointments, deciding the impact of the new appointment and entering the new appointment information, among numerous other examples.

Access to networks such as the Internet promises vast opportunities to access and utilize information, such as E-commerce, conferencing, banking and investing, group collaboration, remote access, centralized storage, etc. However, persisting inefficiencies such as those given above are more likely to become overwhelming to a user attempting to actually find or use such resources. A user will face more music, video, graphics or other information to weed through, let alone consider in making a viewing or purchasing decision. An electronic calendar, message, contact or other application user will likely be faced with even more less-pertinent information, and the amount of information will likely continue to increase. To make matters worse, tool complexity and data incompatibilities will likely increase and interface usability will decrease with newer technologies; security concerns, which already plague particularly network users, will also likely become even more problematic.

Accordingly, there is a need for a system and methods, particularly where a network is utilized, that are capable of providing a user with more pertinent information There is a further need for systems and methods that facilitate more flexible and effective information handling. There is a further need for a system and methods that are capable of providing such information in a secure yet efficiently utilizable manner.

### SUMMARY

The present invention provides systems and methods that enable more pertinent “vendors” and/or “products”, including network accessible resources, to be more securely and flexibly provided to and utilized by users, such as product consumers. Aspects provide for ascertaining cognitive characteristics of consumers, such as theirs or others' personality traits and motivations, as well as factual and other user/group specific information. Aspects also provide for ascertaining cognitively-oriented, factual and/or parameterized information about “products,” such as objects, services and other things capable of satisfying actual or potential user needs, intent, desires or interests, and similarly of vendors (including product-vendor correspondences).

Aspects also provide for determining correspondences between the user/consumer and product/vendor information, and further in accordance with varying applications, devices and/or processes. Aspects still further provide for presenting and otherwise utilizing such information in a useful, efficient and non-intimidating manner, and for conducting these and other aspects in a secure, extensible and functionally and implementationally flexible manner.

A system embodiment comprises communicatingly coupled devices including one or more wish servers for determining and/or matching cognitive and factual consumer information with corresponding cognitive, factual and parameterized product/vendor information; and one or more consumer devices for providing consumer information to the wish server and for presenting to/for a consumer product/vendor matches. System embodiments can also include elements such as a coordinator for securely sharing, distributing and/or consolidating consumer, product, application code and/or other information residing on different coupled devices.

A wish server embodiment comprises a consumer portrayer engine for forming one or more consumer portraits from cognitive (e.g. personality) and factual consumer information, a product-vendor portrayer for forming one or more product and/or vendor portraits from cognitive, factual and parameterized product/vendor information; and a matching engine for determining one or more products/vendors corresponding to the one or more of the consumer portraits, further consumer information (e.g. objectives) and/or other information (e.g. factual consumer information corresponding to certain product types, parameters of one or more applications, etc.).

Wish server embodiments can also include one or more of an application engine for initiating resident, external and/or mobally implementable application program code, an interface engine for providing suitable portraying, matching and/or presenting interfaces, a viability engine for determining viability (e.g. need, usefulness, reliability, etc.) of the information, and a security engine for providing one-way encryption/decryption, portrait sketch utilization and/or other security capabilities. Wish server embodiments can also include elements such as one or more of consumer, product and/or vendor monitoring engines for monitoring/updating consumer, product and/or vendor portraits, sketches or other information, and/or a transaction engine for providing automatic (e.g. programmatic) and/or user determinable view, purchase, implement or other simple, composite or other transactions, among others.

A consumer portrayer engine embodiment comprises a cognitive basis engine for determining consumer-information (e.g. age, sex and/or culture) in accordance with which a cognitive basis can be formed; a portrait engine for determining cognitive consumer information relating to consumer attitude or predisposition (e.g. personality), preferably corresponding to the cognitive basis; an objectives engine for determining consumer objectives (e.g. intent and/or long term interests); and a facts engine for determining consumer facts (e.g. relating to identifiable product types or categories).

A consumer portrait engine embodiment can, for example, comprise a portrait tool for providing to a consume-device user an interactive interface for determining a consumer cognitive profile including weighted cognitive (e.g. personality) aspects in accordance with a determined consumer cognitive basis (e.g. of the user, another, a group, a thing, a person with respect to a thing, etc.), and a portrait analyzer for determining a system utilized consumer portrait corresponding to (but that can differ from) the profile (e.g. including differing aspects, weights, representations, etc.).

An interface embodiment can, for example, include a personality selector or “mixer” enabling the user to assign/modify weights corresponding with one or more personality aspects in accordance with a determined consumer cognitive basis, and a personality profiler for providing feedback (e.g. an audio and/or visual presentation) to the user as to various combinations of resulting ones of the weighted cognitive aspects (e.g. representing a resulting complete consumer profile).

A product-server (or “product-vendor server”) embodiment comprises a product ascertaining engine for ascertaining explicit and cognitive product, service and/or vendor information; and a product portrait analyzer for forming product portraits from explicit and cognitive products information. Product server embodiments can also include elements such as a product information monitoring engine for modifying a product (information-based) portrait, portrait sketch or other product information, a viability engine for analyzing ongoing information need, reliability or usefulness, and/or a security engine. A suitable product ascertaining engine embodiment can also include a product portrait engine, product spider engine or other device or process for ascertaining product information.

A product portrait engine embodiment comprises an explicit information engine for ascertaining explicit “product” (i.e. product, service, vendor or other non-consumer) information, a cognitive product information engine for ascertaining cognitive product information (e.g. associated with a portion of the explicit product information), and a product portrait analyzer for analyzing the cognitive and optionally other product information, and determining therefrom a product portrait or shadow-based portrait, product-applicability intent and product-applicability actual or prospective long-term interests. A suitable product portrait engine embodiment can, for example, also include a cognitive product interface engine.

A product spider engine embodiment can comprise a resident or mobile code template creator for ascertaining structure and functionality of a network resource (e.g. product/vendor web site), a spider engine for ascertaining “product” (i.e. product, service, vendor or other non-consumer) information in accordance with the ascertained structure and functionality information, and a product portrait analyzer for analyzing the cognitive and optionally other product information and determining therefrom a product portrait, shadow-based portrait, product-applicability intent or product-applicability prospective long-term interests.

An information-ascertaining cognitive interface engine embodiment comprises a controls engine for presenting a user with controls for indicating a plurality of cognitive characteristic values corresponding to at least one of user information or products information, and a feedback engine for presenting to the user a profile depiction including media representing the cognitive characteristic values. Such cognitive characteristic values can, for example, include user personality or product information personality aspects; and the media depictions can include, for seeing users, graphic objects representative of the type and extent of the personality aspects. (One or more other multimedia, biometric or other sensory stimulating feedback can also be utilized.)

A suggestion cognitive interface engine embodiment comprises a suggestions engine for presenting to a user action, intention, long-term interest or other information in accordance with a user portrait, shadow portrait, product matching, application program code or other information; a controls engine for presenting a user with controls for indicating suggestion acceptance, rejection, modification or alternatives; and a response initiator for returning to a wish or product server monitor a user response. (The user response can, for example cause corresponding system actions such as further consumer presentation or feedback, modification of a consumer portrait, shadow or other information, initiation of matching and/or initiation of corresponding application program code.)

A security engine embodiment comprises a one-way encryption engine for storing selectable portions of user information in an unencrypted form linkable via one or more encrypted linking indicators to an encrypted user information portion, a linking engine for enabling the encrypted information to be utilized by a qualified user, and a secure access engine for enabling one or more users to cause the encrypted user information portion to be selectively utilized.

A method embodiment comprises receiving explicit and cognitive consumer-user information and forming therefrom a consumer portrait; receiving explicit and cognitive product information selected from a group including product, service and vendor information, and forming therefrom one or more product portraits; and determining a set including at least one of the product portraits and zero or more corresponding ones of the consumer portraits. The determining can, for example, be further conducted in accordance with a current application program code portion.

A further method embodiment comprises receiving explicit consumer information; determining therefrom corresponding cognitive consumer information types; receiving consumer information corresponding to the information types; and forming a consumer portrait from at least a portion of the cognitive consumer information. The explicit consumer information can, for example, include consumer sex and/or culture information, and the cognitive consumer information can, for example, include consumer personality information.

A further method embodiment comprises receiving a consumer portrait and consumer information about a consumer-user, determining one or more reliable information portions of the received consumer information; initiating application program code; and determining products corresponding to the consumer portrait, the determined reliable information portions and the application program code portion.

Advantageously, embodiments of the invention are capable of securely and flexibly providing a consumer, group of consumers or persons for whom one or more consumers is/are acting with more pertinent “products” in accordance with one or more of a variety of applications. Embodiments are further capable of procuring—even purchasing or conducting other aspects of utilizing such information—in a manner more applicable to a particular consumer or consumer group. Information is also maintainable in a secure, yet useful, up-to-date and reliable manner. Embodiments are further capable of interfacing with users in a friendly and easily utilized and efficient manner, for example, utilizing suggestions for which even contrary user responses provide useful accuracy improving information. Embodiments also enable information to be ascertained and utilized in an adaptable and extensible manner with varying types and configurations of users, devices or processes.

For example, a suggestion might be provided that a calendar time-slot might be filled with one or more reliably determined appointments that might be achieved in a separate, linked or coexisting manner; user responses or other ascertainable conditions (e.g. traffic conditions) might further be used to modify the current or a future suggestion. Clothing, a meal, travel information, a gift or other products might further be suggested, as well as an appropriate store, restaurant or agency suitable to one or more affected users. User information is also maintainable in a secure, substantially anonymous manner, while enabling ongoing analysis and increasingly accurate predictions, among other advantages.

### BRIEF DESCRIPTION OF THE DRAWINGS

FIG. 1 is a block diagram illustrating a matching-system, in accordance with an embodiment of the present invention;

FIG. 2 is a block diagram illustrating an exemplary computer system capable of implementing one or more of the elements of FIG. 1;

FIG. 3 is a block diagram illustrating a wish server according to an embodiment of the invention;

FIG. 4 is a block diagram illustrating, in greater detail, an application engine of the wish engine of FIG. 3, according to an embodiment of the invention;

FIG. 5 is a block diagram illustrating, in greater detail, an interfacing engine of the wish engine of FIG. 3, according to an embodiment of the invention;

FIG. 6 is a block diagram illustrating, in greater detail, a portrayer engine of the wish engine of FIG. 3, according to an embodiment of the invention;

FIG. 7a is a block diagram illustrating, in greater detail, a portrait engine of the portrayer engine of FIG. 6, according to an embodiment of the invention;

FIG. 7b illustrates an exemplary user interface for determining cognitive aspects, according to an embodiment of the invention;

FIG. 7c illustrates a further exemplary user interface for determining cognitive aspects, according to an embodiment of the invention;

FIG. 8 is a block diagram illustrating, in greater detail, a usage monitor of the portrayer engine of FIG. 6, according to an embodiment of the invention;

FIG. 9 is a block diagram illustrating, in greater detail, a matching engine of the wish engine of FIG. 3, according to an embodiment of the invention;

FIG. 10 is a block diagram illustrating, in greater detail, a data and communications management engine (“management engine”) of the wish engine of FIG. 3, according to an embodiment of the invention;

FIG. 11 is a block diagram illustrating, in greater detail, a viability engine of the wish engine of FIG. 3, according to an embodiment of the invention;

FIG. 12 is a block diagram illustrating, in greater detail, a transaction engine of the wish engine of FIG. 3, according to an embodiment of the invention;

FIG. 13a is a block diagram illustrating, in greater detail, a security engine of the wish engine of FIG. 3, according to an embodiment of the invention;

FIG. 13b is a flow diagram illustrating the operation of matching system elements for providing one-way encryption, decryption and portrait sketches, according to an embodiment of the invention;

FIG. 14a is a block diagram illustrating a product-vendor engine according to an embodiment of the invention;

FIG. 14b illustrates data structures that are facilitated by matching-system elements, according to an embodiment of the invention;

FIG. 15 is a flowchart illustrating a method for matching consumers and products according to an embodiment of the invention;

FIG. 16 is a flowchart illustrating a method for matching consumers and products and/or vendors according to an embodiment of the invention;

FIG. 17a is a flowchart illustrating a further method for matching consumers and products and/or vendors according to an embodiment of the invention;

FIG. 17b is a continuation of the FIG. 17a flowchart;

FIG. 18 is a flowchart illustrating a method for creating a product portrait according to an embodiment of the invention;

FIG. 19 is a flowchart illustrating a method for creating a consumer portrait according to an embodiment of the invention;

FIG. 20 is flowchart illustrating a method for creating a consumer portrait mapping according to an embodiment of the invention;

FIG. 21 is a flowchart illustrating a further method for creating consumer portraits according to an embodiment of the invention;

FIG. 22 is a flowchart illustrating a method for defining explicit attributes and preferences according to an embodiment of the invention;

FIG. 23 is a flowchart illustrating a consumer portrait creation method according to an embodiment of the invention;

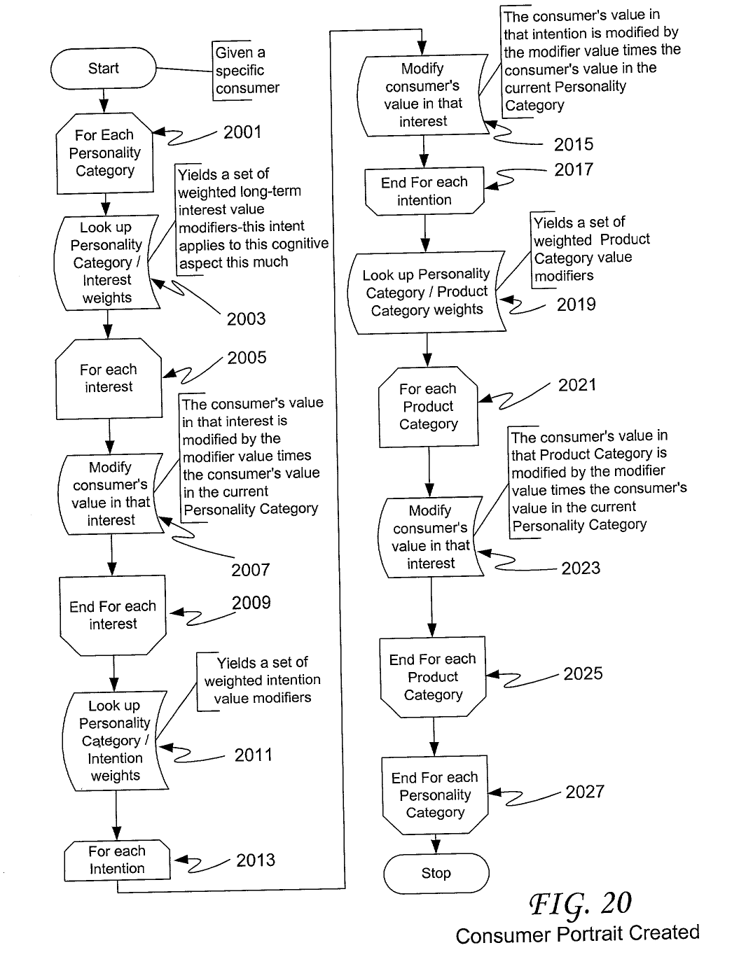

FIG. 20 is a flowchart illustrating a further digital portrait definition method according to an embodiment of the invention;

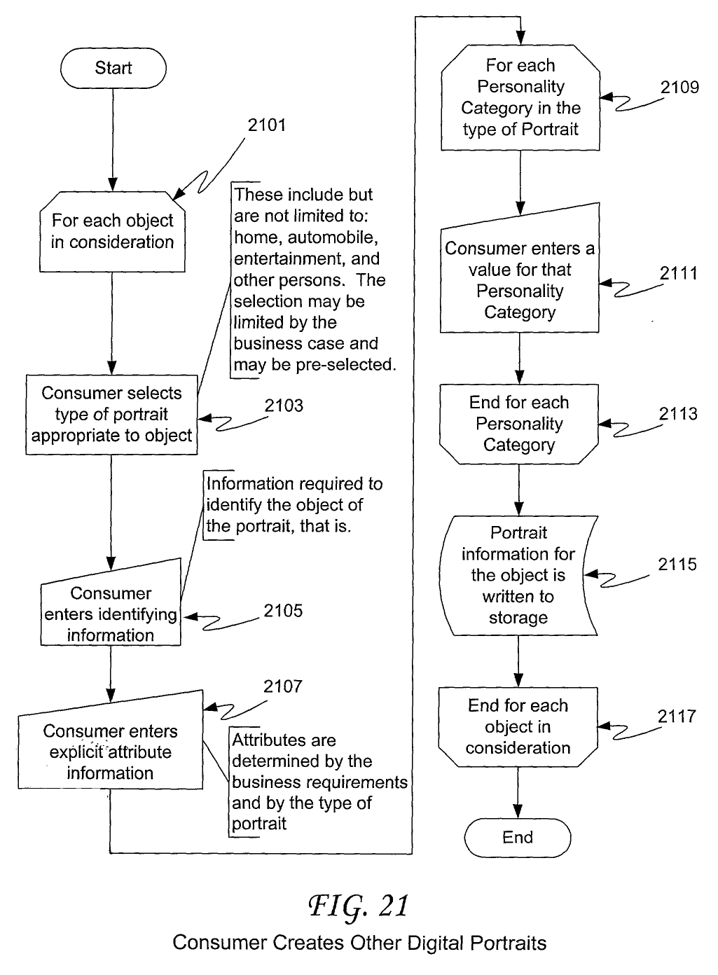

FIG. 21 is a flowchart illustrating a consumer interest map creation and modification method according to an embodiment of the invention;

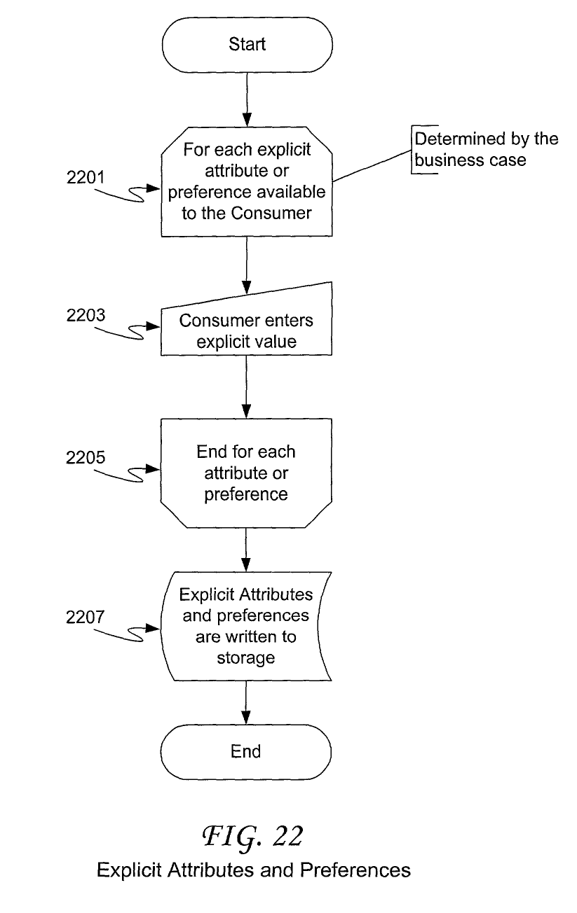

FIG. 22 is a flowchart illustrating a context determination method according to an embodiment of the invention;

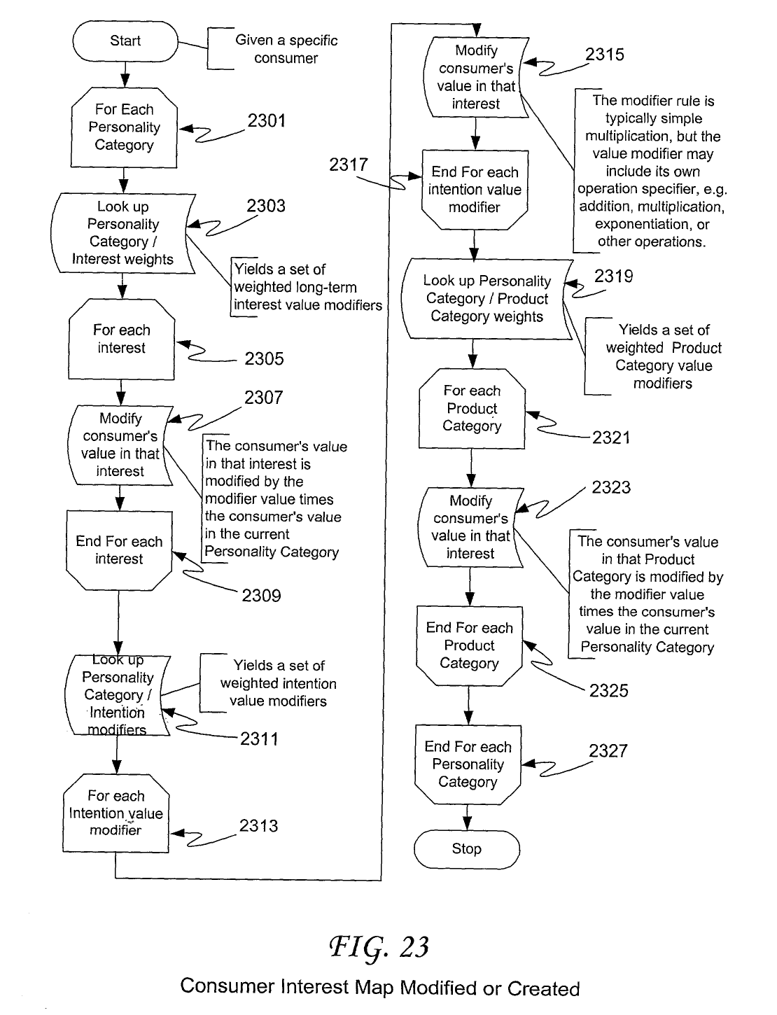

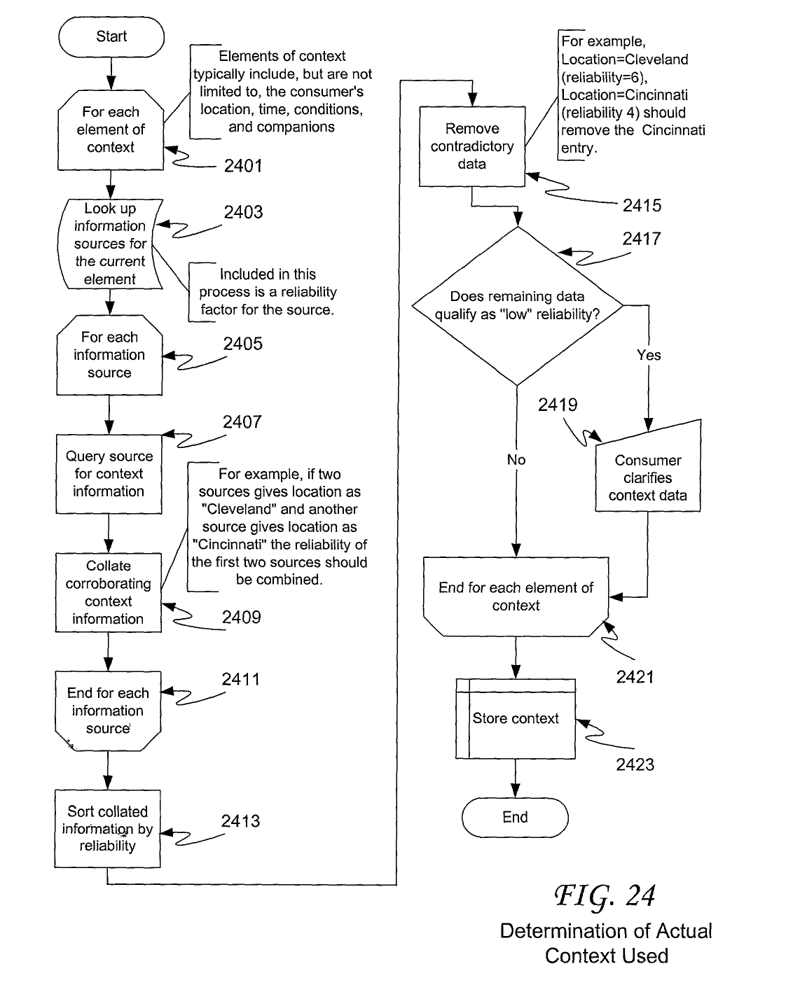

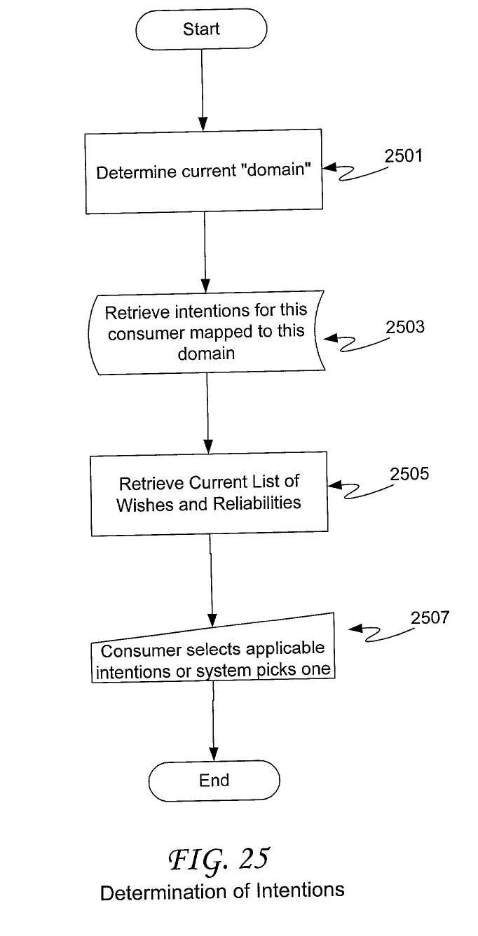

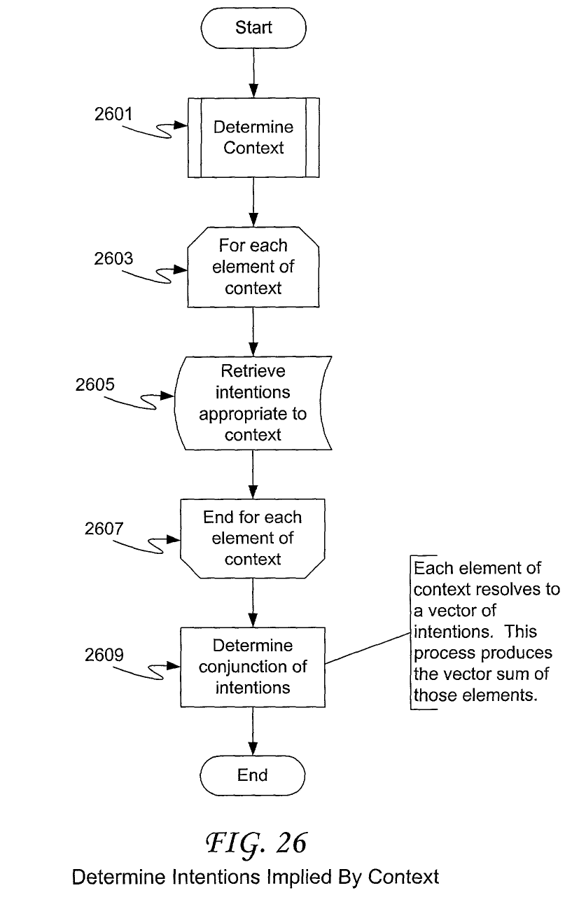

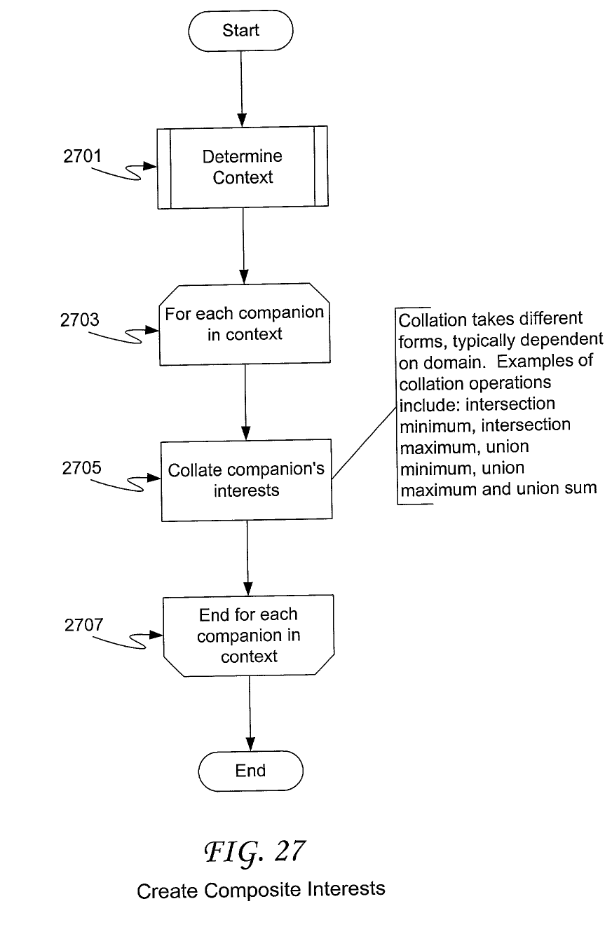

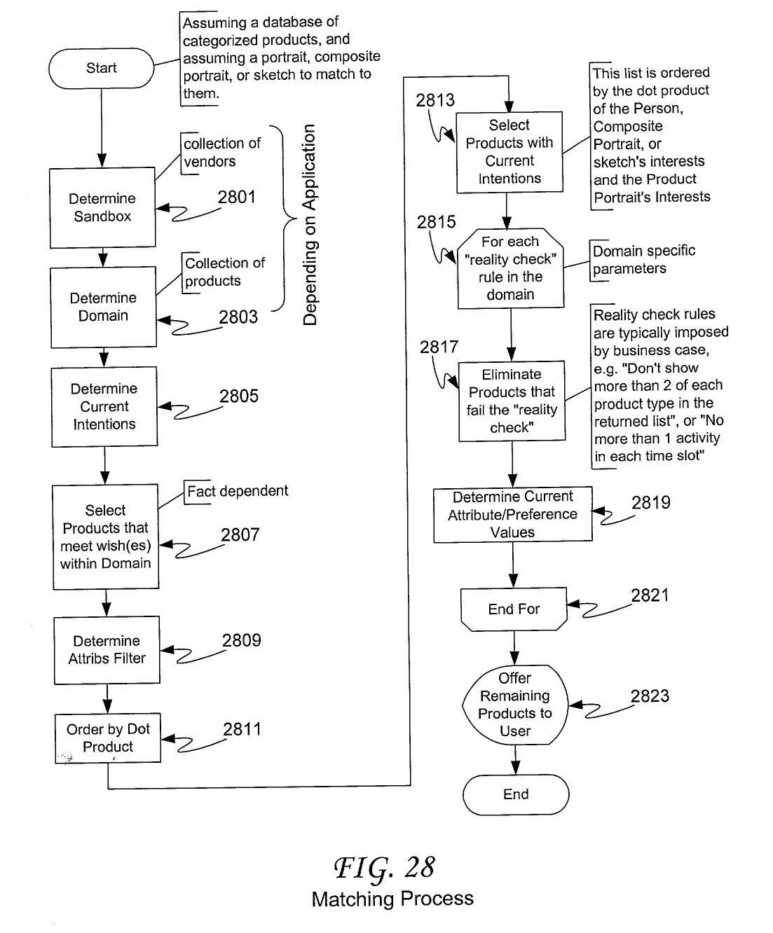

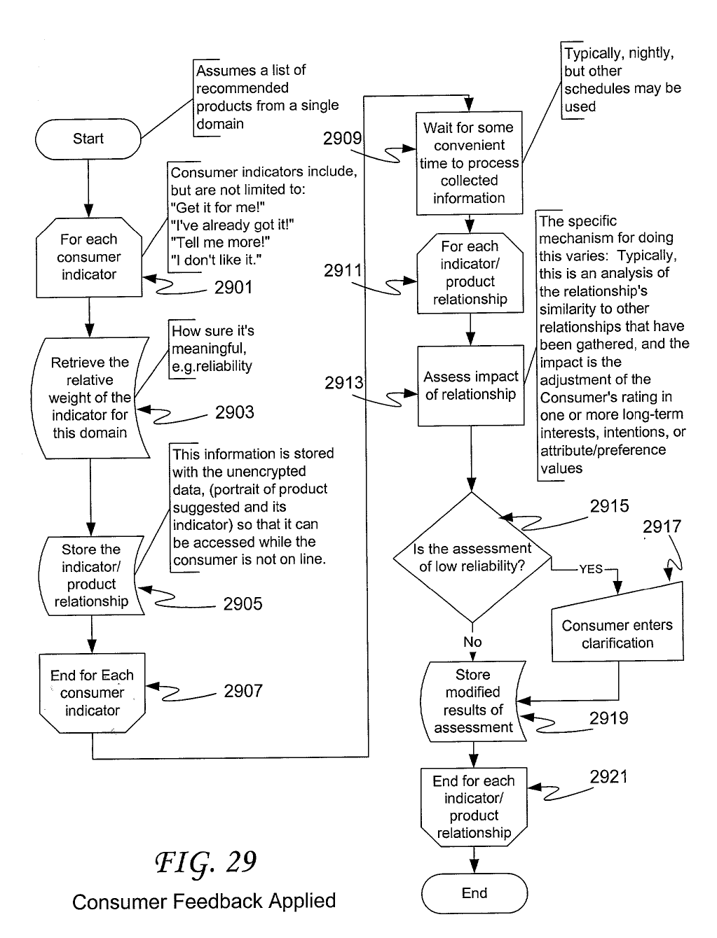

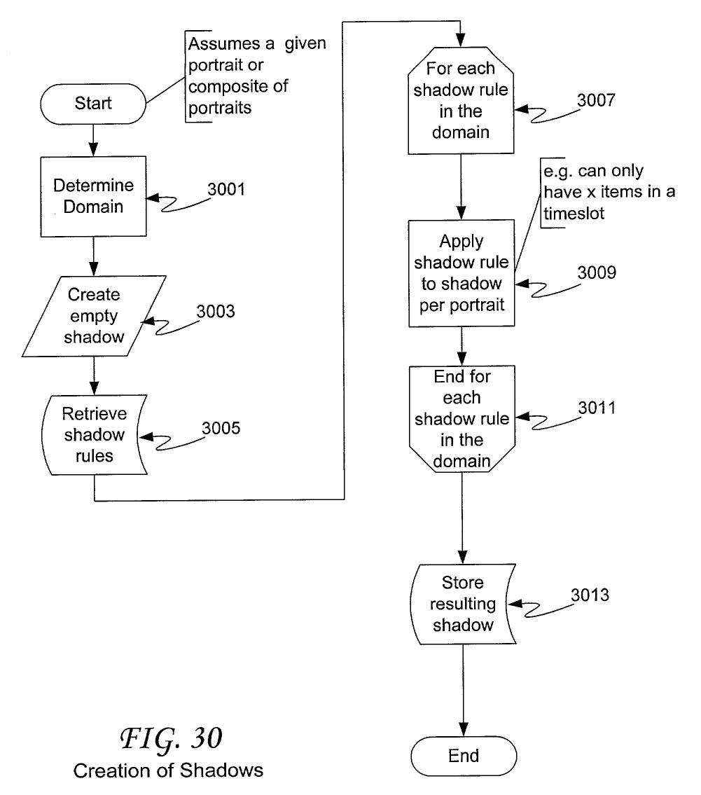

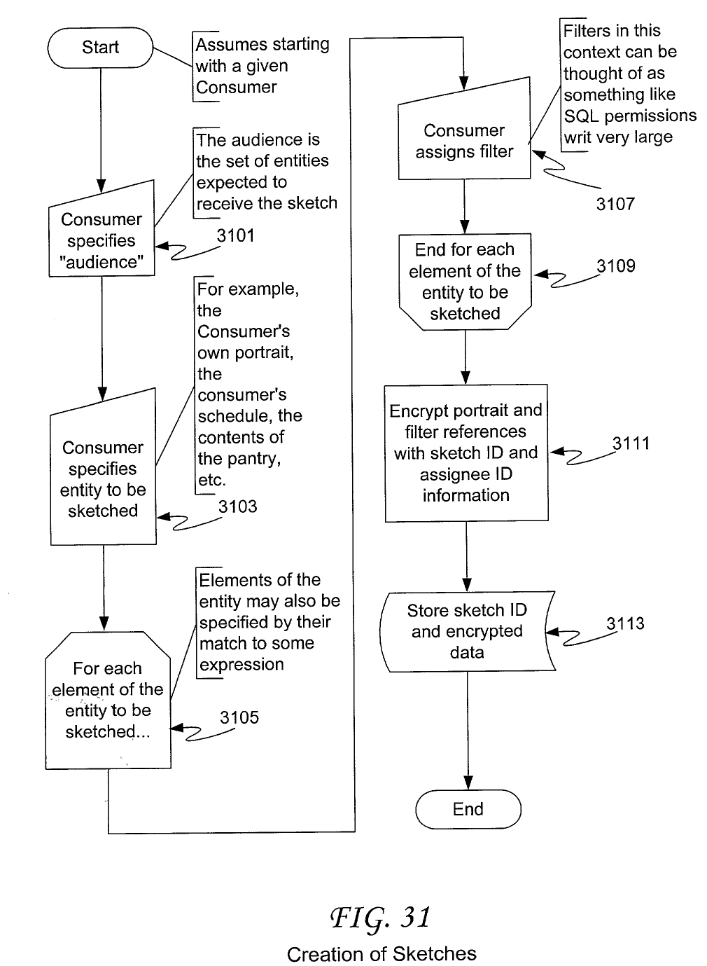

FIG. 23 is a flowchart illustrating an intent determination method according to an embodiment of the invention;

FIG. 24 is a flowchart illustrating an implied intent determination method according to an embodiment of the invention;

FIG. 25 is a flowchart illustrating a composite interests creation method according to an embodiment of the invention;

FIG. 26 is a flowchart illustrating a matching method according to an embodiment of the invention;

FIG. 27 is a flowchart illustrating a method for applying consumer feedback according to an embodiment of the invention;

FIG. 28 is a flowchart illustrating a shadow creation method according to an embodiment of the invention;

FIG. 29 is a flowchart illustrating a sketch creation method according to an embodiment of the invention;

### DETAILED DESCRIPTION

In providing for matching one or more consumers with one or more products, embodiments of the invention enable entirely new approaches to information determining and utilization. Embodiments enable one or more consumers and their explicit or determined objectives and relevant facts to be portrayed, monitored and/or modified according to similar discovered cognitive and factual consumer information criteria. Embodiments also enable one or more products and/or vendors and corresponding objectives and parameters to be portrayed, monitored and/or modified according to similar discovered cognitive and factual product/vendor information criteria. Embodiments also enable such criteria to be variably communicated with a consumer, yet similarly utilized in further accordance with discovered cognitive bases. Embodiments further enable more extensively descriptive particularly product categorization and parameterization information to be efficiently processed and pared down to ordered products that are determined to be presently most pertinent.

In accordance with the above and other aspects, a particularly broad range of consumers, products and vendors are supportable. A consumer can include any end user by or for which the matching-system is utilized. Products can include one or more tangible or intangible things, people, characteristics, places, services, time utilizations, network resources or essentially anything else that is capable of satisfying one or more actual or potential consumer needs, desires, intents and/or interests. Vendors can include any animate, inanimate, real, virtual or other supplier or facilitator of any one or more products.

Embodiments of the invention also enable highly flexible consumer and product/vendor matching and presentation to be conducted. For example, product and/or vendor information corresponding to consumer information of one or more consumers or consumer groups (e.g. household, companions, participants, etc.) can not only be determined as “matches,” but the results can also be “presented” to or for one or more of the same or other consumers or groups in diverse ways.

Corresponding product and/or vendor information can, for example, be presented as a single or multiple media presentation via one or more system-accessible consumer devices or processes (e.g. via a settop box, smart or conventional phone and/or PDA). Other predetermined, system-determinable or consumer-requested actions for or on behalf of a requesting consumer, group and/or others can also be conducted or facilitated (including but not limited to window shopping, sampling, purchasing, scheduling, interoperating with various wired or wirelessly accessible devices or processes, etc.). Useful interfacing, security, viability determining and/or other aspects can also be provided in accordance with the teachings herein.

For clarity sake, the following discussion will reference a more specific “Personal Genie” implementation example according to which various aspects of the invention might be better understood. Accordingly, matching will be discussed in terms of a useful Personal Genie “wish fulfillment” environment. That is, products and/or vendors can be viewed within such an environment as things capable of (separately or together) fulfilling consumer wishes; matching and presenting can further be viewed as attempting to fulfill one or more determinable or explicitly expressed consumer wishes in accordance with corresponding products/vendors, applications, contexts, information viability and/or other factors. (The terms “engine” or “matching-system process” and “matching-system tool” will also be used interchangeably in order to facilitate discussions with regard to internal matching-system elements or operation and application servicing respectively.)

The Personal Genie implementation more specifically enables similar matching-system utilized consumer “portraits”, “intents” and “long-term interests” to be determined by analyzing variably characterizable consumer-supplied personality ratings. Such aspects can further vary in accordance with differing “cognitive bases”, such as age, sex and culture, and/or consumer “perspectives”, such as applying differing aspects or ratings systems to characterize oneself versus one's child. The Personal Genie also enables similar product/vendor portraits, intents and long-term interests to be determined by analyzing further product (or vendor) personality criteria as might be more meaningful to a characterizing vendor. Consumer information can further include pertinent supplied, inferred or otherwise ascertained facts, and products and/or vendors are further classified in accordance with any number of factual and cognitively (e.g. wish-fulfillment) oriented categories and fulfillment/presentation parameters that might apply (e.g. product importance or likely relevance). Such information can further be securely stored and retrieved for use by one or more consumers or consumer groups from one or more local or remote storage devices.

The Personal Genie implementation further enables matching, presentation, monitoring and updating to be initiated automatically (e.g. programmatically) or via a request message from a matching-system accessible device or one or more applications. Matching includes determining correspondences between consumer, product and/or vendor portraits, and further paring down such correspondences in accordance with application constraints, applicable context aspects (e.g. time/place), inferred or expressed intent, long-term interests, product-applicable facts (e.g. size/color preferences) and/or other factors, such as the applicable information reliability and/or relevance.

Personal Genie presentation can further be conducted according to consumer and/or product-supplying device availability (e.g. when a consumer uses the matching-system, applicable information is otherwise received, upon application request, in conjunction with the occurrence of an applicable transaction event, or in accordance with corresponding consumer or product parameters.) Monitoring and updating of portrait or other information can similarly be conducted in accordance with automatic, consumer or vendor supplied updates or as a result of matching or presentation (and can be effectuated in accordance with applicable device availability).

It will become apparent, however, that aspects of the invention are particularly extensible and adaptable, and various aspects are capable of being utilized separately or in a more integrated manner in accordance with a wide variety of application and/or other implementational considerations. (Note that the term “or” is used herein to mean “and/or” unless otherwise indicated.)

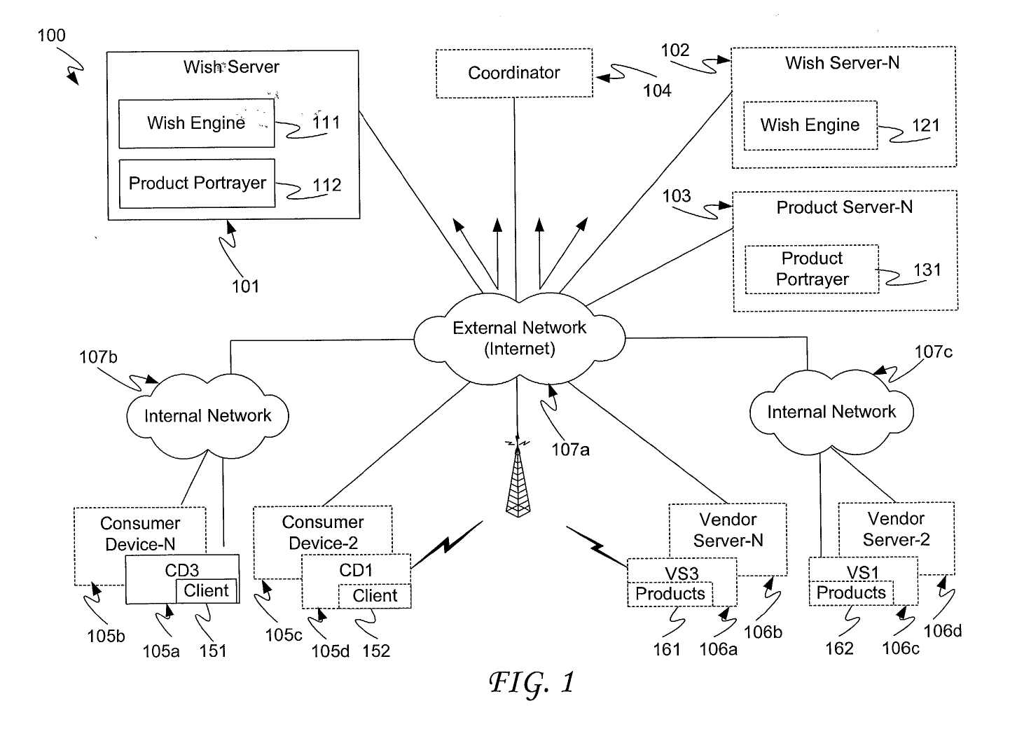

Turning to FIG. 1, a suitable matching-system example is illustrated according to an embodiment of the invention. As shown, matching system 100 comprises at least one wish-server 101 for determining consumer and product information and providing matching and presenting services to or for at least one consumer. Matching system 100 also includes at least one consumer device 105a for providing consumer information to wish-server 101 and for presenting matching results to or for the consumer corresponding to the consumer device operation. (Thus, matching system 100 is capable of providing wish fulfillment and other services via consumer or other devices operated in a particular instance by, for or otherwise with regard to one or more consumers, such as with an ATM, PC, mainframe, scanner, refrigerator, phone, smart home element, remote control, vehicle, GPS, alarm, entertainment system, PDA, etc.)

Matching-system 100 is, however, extensible and its configuration can vary considerably in accordance with a particular application. For example, additional matching-system servers in addition to wish-server 101 can also be utilized, and can include one or more (separated or combined implementation) wish-servers 102 or product servers 103. Matching-system servers can also include one or more coordinators 104 for facilitating more widely applicable inter-element operations, such as system setup, administration, analysis and secure inter-element messaging, among others. Matching system 100 can further include one or more product provider/facilitator or “vendor” servers 106a-d for providing a source of product or vendor information useable by one or more of the matching-system servers.

In a matching-system consistent with the Personal Genie implementation, for example, an Internet service provider (“ISP”) might provide a subscribing wish-services consumer with initial and ongoing portraying, monitoring, updating and wish fulfillment services. In such cases, a combined wish-server providing consumer and product/vendor portraying coupled to one or more consumer devices and vendor servers (e.g. supplying potentially varying source product/vendor information) would likely be used. It is, however, possible that certain services, such as product portraying, might be conducted elsewhere and that information determination might include utilizing information stored or received by one or more wish-server devices or processes, among other permutations.

FIG. 1 also illustrates how one or more matching-system 100 elements can be coupled directly or indirectly via one or more suitable interconnected networks 107a-c. The depicted configuration includes, for example, a wide area network (“WAN”) 107a such as the Internet, and further local area networks (“LANs”) 107b-c that might also be utilized (which are distinguished for discussion purposes as external and internal networks respectively.) Any suitable static or re-configurable network or networks can, however, be utilized, such as virtual private networks (“VPN's”), home networking; X.25 networks, asynchronous transfer mode (“ATM”) networks, proprietary networks and wireless application protocol (“WAP”) networks, among others. One or more forms of network protection, such as a firewall or certification, might also be employed (not shown). In such cases, any suitable mechanism for transferring affected information (e.g. Java™ applets, ActiveX™ components, other so-called “mobile code”, certificates, etc.), or for otherwise accommodating such network protection can also be utilized in accordance with a particular implementation or other considerations.

Wish server 101 includes wish engine 111 and product portrayer 112. Wish engine 111 provides for determining, sharing and consolidating initial and ongoing cognitive and factual consumer information, receiving product information, performing matching, presenting, monitoring and consumer and product/vendor information updating. Wish engine 111 also conducts security and other wish server services.

Operationally, wish engine 111 supplies an interactive interface for receiving initial consumer information from which it forms a consumer portrait. Wish engine 111 also receives product/vendor portrait and other product/vendor information from product-vendor portrayer 112 and other coupled devices or processes, conducts updating and matching and initiates presentation and other operations as needed. (Other examples of system 100 mechanisms for handling consumer, product and information will also become apparent.) Wish engine 111 also provides for communicating or interoperating with a diverse variety of consumer devices and for conducting or otherwise facilitating a diverse variety of products/vendors and applications (not shown).

Product portrayer 112 is capable of operating in a similar manner as with wish engine 111 for receiving product or vendor information from a vendor server user and forming therefrom a product or vendor portrait and other vendor information respectively. In such cases, product portrayer provides to the vender server user an interactive interface with which the user returns cognitive and factual product (or vendor) information. In the Personal Genie implementation, the product (or vendor) information includes rating indicators for each of a set of cognitive information aspects, and explicit factual information. Product portrayer 112 analyzes the product (or vendor) information to form a product (or vendor) portrait, intent and long-term interest information, which it communicates (via messaging) to wish engine 111. Product portrayer 112 is also capable of determining automatically, e.g. programmatically, the product information, and each of product portrayer 112 and wish engine 111 is capable of providing default portraits or of receiving applicable information in other forms, such as data files. Product portrayer 112 or wish engine 111 elements also perform product/vendor monitoring and information updating as needed, and typically automatically.

Coordinator 104 provides for centralized matching-system services. In the Personal Genie, for example, matching-system 100 operation typically includes more localized consumer, product and vendor information utilization. That is, each consumer typically subscribes to a combined “Genie-enabled” wish server (i.e. including a wish engine and a product portrayer) to which any number of product vendors might also subscribe, and nearly all operations of or concerning the consumer are conducted using that wish server (e.g. wish server 101). However, the consumer might acquire permission to also utilize an other consumer's consumer information or wish to utilize other product information residing on another server (e.g. wish-server 102 or product server 103). The consumer might, for example, be conducting a meal, travel, meeting, automatic or interactive purchasing, or other “wish” for which the other consumer will be a companion or participant, or will be affected in some other respect. In such cases, coordinator 104 receives and forwards a request from the first wish server to the other server and forwards the other server response back to the first wish server for further processing. (See, for example, the discussion of security below).

Coordinator 104 can, however, also provide additional services. For example, coordinator 104 can also distribute program code or other information for setting up or maintaining various servers or consumer devices. Coordinator 104 is also capable of providing a centralized communication or distribution point for supporting a more distributed implementation (e.g. for facilitating distribution, modification or storage of commonly subscribed product, vendor or consumer information), usage or cognitive/factual informational analysis or testing, or other operations. More than one coordinator might also be used to facilitate these or other globally or locally centralized services in accordance with a particular application or other considerations.

Consumer devices 105a-d can comprise any device capable of communicating with or being otherwise accessible by other matching system 100 elements. As depicted in FIG. 1, one or more of consumer devices 105a-d can include a network client, such as an Internet browser (e.g. Netscape Communicator™, Microsoft Internet Explorer™, etc.) or email client (e.g. 151, 152) or other such elements (e.g. a Java Virtual Machine) for communicating with wish server 101. In such cases, a consumer device client might connect continuously or intermittently to the Internet, access a wish server and issue hypertext transfer protocol (“HTTP”) requests in accordance with wish server provided web pages, mobile code or other elements. PCs, certain PDAs and smart appliances (among other devices) might thus benefit from existing and emerging standardization, rich media and flexibility of such well-established communication techniques. However, another consumer device, such as a conventional phone, might communicate with wish server 101 via user speech, speech recognition/synthesis or signaling. A still further computing device, such as certain PDAs, settop boxes, ATMs, remote control devices, smart appliances, entertainment system elements and the like, might utilize one or more installed program modules, downloadable code, other mobile code or specialized signaling hardware or software. Wish server 101 is configurable for operating with these and other device or communication implementations possibilities as well.

Vendor servers 106a-d can similarly comprise any number of devices that are capable of communicating (at least initially and more preferably on an ongoing basis) product/vendor information with wish server 101 or another wish/product server. As was already noted, product/vendor information can be communicated via an interactive interface; further wish server tools are also provided for automatically “scanning” a vendor server provided URL or other continuously or intermittently remotely accessible coupled resource for product information. However, a vendor server might also comprise a brick and mortar business with or without a computing device that is connected to the Internet or that is not otherwise remotely accessible. In such cases, other suitable methods, such as file or even paper transfer and conversion to electronic form, can also be utilized.

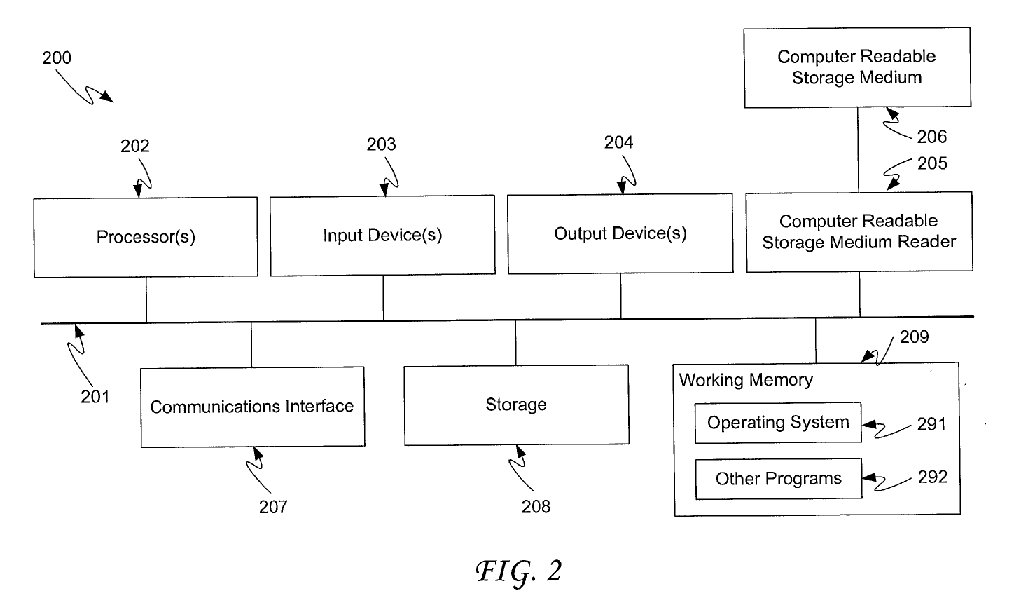

FIG. 2 illustrates an exemplary computing system 200, such as a PC (or other suitable processing system), that can comprise one or more matching-system elements. While other application-specific device/process alternatives might be utilized, such as those already noted, it will be presumed for clarity sake that system 100 elements (FIG. 1) are implemented by one or more processing systems consistent therewith, unless otherwise indicated.

Computer system 200 comprises elements coupled via communication channels (e.g. bus 201) including one or more general or special purpose processors 202, such as a Pentium® or Power PC®, digital signal processor (“DSP”), etc. System 200 elements also include one or more input devices 203 (such as a mouse, keyboard, joystick, microphone, remote control unit, tactile, biometric or other sensors, etc.), and one or more output devices 204, such as a suitable display, joystick feedback components, speakers, actuators, etc., in accordance with a particular application.

System 200 also includes a computer readable storage media reader 205 coupled to a computer readable storage medium 206, such as a storage/memory device or hard or removable storage/memory media; such devices or media are further indicated separately as storage device 207 and memory 208, which can include hard disk variants, floppy/compact disk variants, digital versatile disk (“DVD”) variants, smart cards, read only memory, random access memory, cache memory, etc., in accordance with a particular application. One or more suitable communication devices 209 can also be included, such as a modem, DSL, infrared transceiver, etc. for providing inter-device communication directly or via one or more suitable private or public networks, such those already discussed.

Working memory further includes operating system (“OS”) elements and other programs, such as application programs, mobile code, data, etc. for implementing system 100 elements that might be stored or loaded therein during use. The particular OS can vary in accordance with a particular device, features or other aspects in accordance with a particular application (e.g. Windows, Mac, Linux, Unix or Palm OS variants, a proprietary OS, etc.). I/O or environmental alternatives capable of being utilized with various OS's can also be utilized, including but not limited to graphic user interfacing, pen-based computing, multimedia, handwriting or speech recognition/synthesis, virtual/augmented reality or 3-D audio/visual elements.

Various programming languages or other tools can also be utilized. (Personal Genie elements are, for example, implemented primarily in Open Java and HTML, and the above-noted interactive interfaces are further written in Macromedia Flash™, using scene advance capabilities to instead communicate user rating selections, and vector graphics capabilities to provide interactive feedback (see below). Finally, certain services are provided using Sun Jini™ technology, and data management is implemented using an Oracle database management system or “DBMS” to store and provide relationally implemented, objective database like storage and retrieval of selectable data elements.)

One or more system 200 elements can, however, be implemented in hardware, software or a suitable combination. When implemented in software (e.g. as an application program, object, downloadable, servlet, etc. in whole or part), a system 200 element can be communicated transitionally or more persistently from local or remote storage to memory for execution, or another suitable mechanism can be utilized, and elements can be implemented in compiled or interpretive form. Input, intermediate or resulting data or functional elements can further reside more transitionally or more persistently in a storage media, cache or more persistent volatile or non-volatile memory, (e.g. storage device 207 or memory 208) in accordance with a particular application.

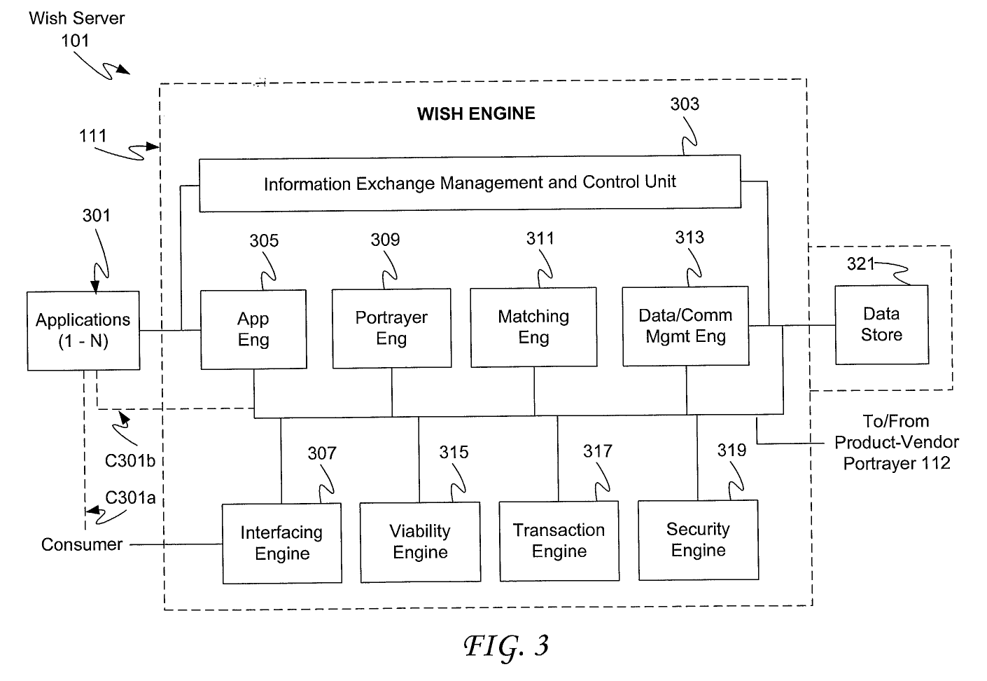

FIG. 3 illustrates an embodiment of wish server 101 of FIG. 1 in greater detail; product portrayer 112 and other potential elements have, however, been removed for greater clarity. (A product portrayer example is considered separately below.)

Wish server 101 can include a wide variety of internally originated applications 301 or externally originated or executed program code (not shown) which can be coupled to and serviced by wish engine 111, product portrayer 112 or other wish server elements. Such applications can further store or retrieve data stored in one or more local or remote data stores indicated by data store 321.

Applications 301 can comprise any individually or concurrently executed application programs, servlets, applets or other program code that are capable of utilizing consumer, product or vendor information, information matching, presentation or other wish server services, including but not limited to those specifically noted herein. (As already discussed, other applications might also be associated with an ISP server or other element or process for which wish server 101 might be an element, and might further utilize data or program code stored in data store 321 or other storage facilities.)

Wish engine 112 includes information exchange management and control unit or “control unit” 303, application engine 305, interfacing engine 307, consumer portraying engine 309, matching engine 311, data and communications management engine or 313, “management engine” viability engine 315, transaction engine 317 and security engine 319. Control unit 303 provides for high level wish-engine control services, such as instantiating and initializing wish-engine processes, establishing data/message communication channels, resolving product parameters and transferring information among wish-engine 111 elements.

Application engine 305 provides for inter-application interfacing, and operation, data, matching and presentation linking. That is, an application can utilize one or more wish engine services, such as consumer coordination, security, analysis, matching, viability testing or presenting, in a separate and distinct manner from other applications. In the more typical case, however, wish-engine 111 provides for a more integrated approach utilizing a common environment and a shared, suggestion based interface, operation and data utilization. Thus, an application or application operation can also be selected and provided to a consumer in accordance with prior or ongoing data gathering/updating, wish fulfillment or other operations; appropriate operational interface elements can further be initiated, appropriate data can be supplied and appropriate matching/presentation can be automatically initiated, thereby reducing resource requirements and providing a more integrated “automatically serviced” user-friendly experience.

Interfacing engine 307 provides for instantiating and facilitating an overall environment, and for determining and instantiating linked application or process interfaces. In the Personal Genie, for example, an assistant or “Genie” is displayed throughout most consumer wish-server utilization. The Genie provides a consumer focal point that appears to make suggestions, receive user information and otherwise facilitate information gathering, monitoring, updating and wish fulfillment. Since a consumer is also presented with only information or actions that have been determined to be viable and pertinent to the consumer or consumers, an overall environment is enabled that is capable of putting a user at ease; the consumer is presented with only a limited number of modifiable “best guess” suggestions and alternatives rather than a “blank page” and a large number of potentially inapplicable generic tools and data. Operationally, Genie suggestions, presentation, operations and other aspects are presented as interface modifications or selectable operations (via addition, substitution, etc.) responsively to processing operations of applications or other wish-server elements, or consumer selections.

Consumer portrayer engine 309 provides for determining cognitive and factual consumer information, and for forming or modifying therefrom consumer portraits, sketches of consumer portraits useable by the same or other consumers, and (at least initial) indicators of potential or explicit consumer “objectives” or wishes. In the Personal Genie, portrayer engine 309 further provides for consumer and “for consumer” (e.g. presentation) monitoring, analysis and consumer information updating in accordance with information received from (potentially) applications 301, or from application engine 303, interfacing engine 307, matching engine 311, management engine 313, viability engine 315 or transaction engine 319.

Matching engine 311 provides for determining products and/or vendors corresponding to cognitive and any appropriate associated factual consumer information for one or more current consumers. Operationally, matching engine receives (typically via control unit 303) one or more cognitive consumer portraits, determined or explicit corresponding consumer objectives and any corresponding factual consumer information. Matching engine 311 also receives (typically by invoking management engine 313) cognitive product/vendor portraits, objectives and any corresponding product parameters (or vendor factual information). Matching engine 311 analyzes the received information, and determines therefrom products/vendors corresponding to the consumer information, a current context and applicable current application parameters. Matching engine further orders the resulting product list according to a relevance product parameter and invokes viability engine 315 to determine (typically) a maximum number of remaining products (or vendors), which matching engine 311 returns to control unit 303. (Control unit 303 typically provides for presenting the matching results if a target consumer or other associated device is presently accessible, or storing the matching results into data store 321 if a target consumer or other associated device is not presently accessible.)

Data and communications management engine (“management engine”) 313 provides for storing and retrieving locally or remotely stored portraits, objectives, factual and/or other information or information updates in accordance with requests from the other wish engine elements, engine 313 also provides for communicating with other matching-system elements, such as coordinators and vendor servers. (As noted earlier, engine 313 can comprise a suitable relational, flat file or objective database management system, a communications interface or one or more other suitable elements.).

Of the remaining wish engine 111 elements, viability engine 315 provides for determining whether gathered or matched information is sufficiently complete, reliable and pertinent. Viability engine receives information from other wish engine 111 or product portrayer 112 elements, analyzes the received information and determines, according to data conflict resolution (e.g. majority agreement), inclusion parameters and other data viability metrics (or by consulting a user) whether portions the information should be utilized or discarded, or whether additional accessible information is sufficiently desirable in providing a particular service (such as matching). Transaction engine 317 monitors and initiates successive or concurrent actions as needed, such as a sequence of wishes, searches, purchases or other transactions. Security engine 319 provides for encryption, decryption, permission assignments and access right checking of personal consumer information that might be utilized by one or more consumers. (Security engine 319 is also capable of implementing a particularly useful and flexible one-way encryption system according to the invention, and other security protocols that might be utilized.)

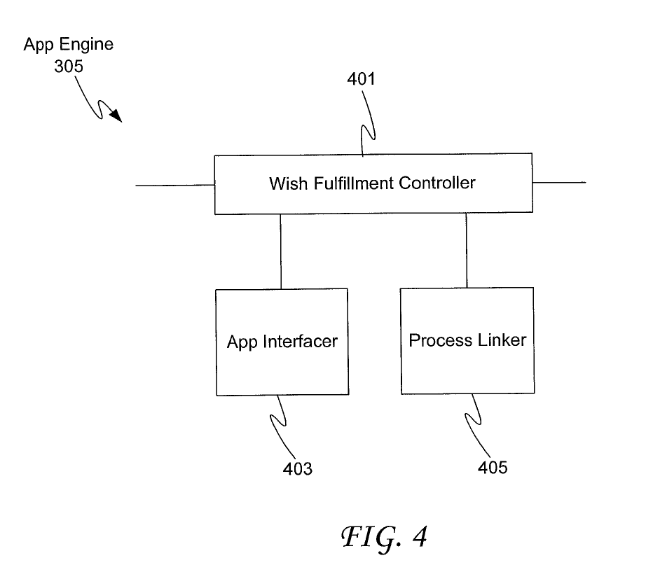

FIG. 4 illustrates how an application engine 305 implementation according to the invention provides for wish-server application intercommunication and interfacing with wish engine elements. In this example, application engine 305 includes a wish fulfillment controller 401, an application interface 403 and a process linker 405. Wish fulfillment controller 401 responds to received message requests from control unit 303 (FIG. 3) by determining whether a requested application is currently instantiated and, if not, instantiates the appropriate application; wish fulfillment controller 401 further communicates data to or from the application or selects an appropriate application process (or processes) in accordance with information exchange protocols, requests or responses from application interface 403 and process linker 405.

Where an operating system such as a Windows variant is utilized, such communication can be conducted via a suitable application program interface or “API” for each application program (provided by application interface 403) and for control unit 303. Process linker 405 further provides for linking of information for determining appropriate corresponding processes and requisite data and data protocols. In this manner, a new application can be readily added to wish server 101, modified or removed by correspondingly modifying the appropriate API and linking information stored in application interface 403 or process linker 405 respectively. It will be appreciated by those skilled in the art, however, that other suitable mechanisms, messaging or transfer protocols can also be implemented in accordance with other types of program code (e.g. Java, extended markup language or “XML” or various forms of mobile code) or other OSs that might also be utilized.

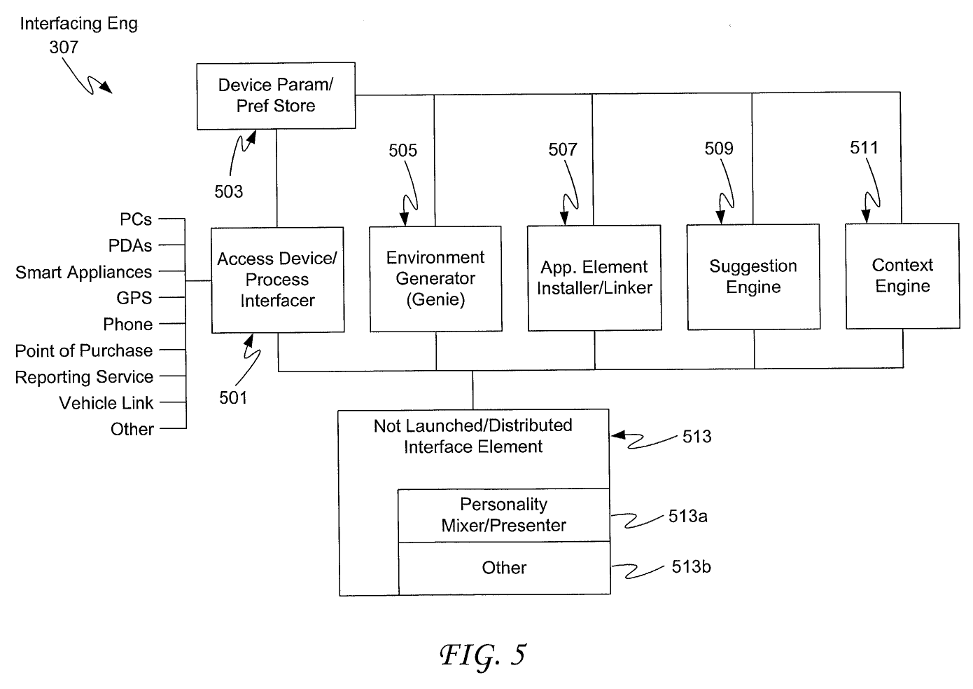

FIG. 5 illustrates how an interfacing engine 307 embodiment according to the invention enables the use of a common environment and integrated device/application interfaces. As with application engine 305 (FIG. 4) and other matching-system elements, interfacing engine 307 provides a modular approach that, in this case, enables interfaces to be formed for a wide diversity of applications or consumer or product/vendor devices or processes in a consistent or otherwise well-integrated manner in accordance with a particular consumer environment.

Suitable devices might, for example, include one or more PCs, PDAs, smart appliances, global portraying system or “GPSs”, phones, point of purchase terminals, reporting systems, kiosks, surveillance systems; cash registers; UPC scanning devices; automated teller machines (ATMs); smart cards; and gasoline pumps and vehicle-based devices, among others. Despite differences or even incompatibilities that might be conventionally encountered, interfacing engine 307 enables a particular device or process to be utilized singly and/or in a useful, coordinated or interchangeable manner in accordance with a particular application.

As shown, interfacing engine 307 includes access device/process interfacer 501, device parameter/preference store 503, environment generator 505, application element installer/linker 507, suggestion engine 509, context engine 511 and interface storage unit 513. Interfacer 501 provides program code executable according to appropriate protocols for communicating with each connected device, typically in conjunction with initiation of a corresponding application or other matching system control. Interfacer 501 can also operate in accordance with device parameters or consumer preferences stored in device parameter preference store 503. Environment generator 505 provides program code for generating a suitable interface basis in conjunction with which more specific device and application interfaces can be presented. (The Personal Genie embodiment, for example, provides a consistent animated assistant presentation that, as with other matching-system elements, interacts with a consumer in an intelligent manner in accordance with their consumer information or other matching-system ascertainable information.)

Of the remaining interfacing engine 307 elements, application element installer/linker (“element installer”) 507 responds to an install message from interfacer 501 for a particular device or process by recalling from interface storage 513 corresponding interface elements, and instantiates the interface elements within the environment. Suggestion engine 509 responds to matching results produced by matching engine 311 (FIG. 3) by forming a suggestion format presentation including the matching results and any appropriate consumer responses. Context engine 511 retrieves from a suitable device (e.g. a timer, GPS, etc.), a consumer or an application, or infers from other available information (e.g. a consumer schedule) time, consumer or product activation location or other contextual condition information and provides such information to an application, matching engine 311 or other matching system-elements via control unit 303. Finally, interface storage unit 513 provides for storing interface elements that have not yet been launched or distributed (for successively launched or remotely initiated interface elements respectively.)

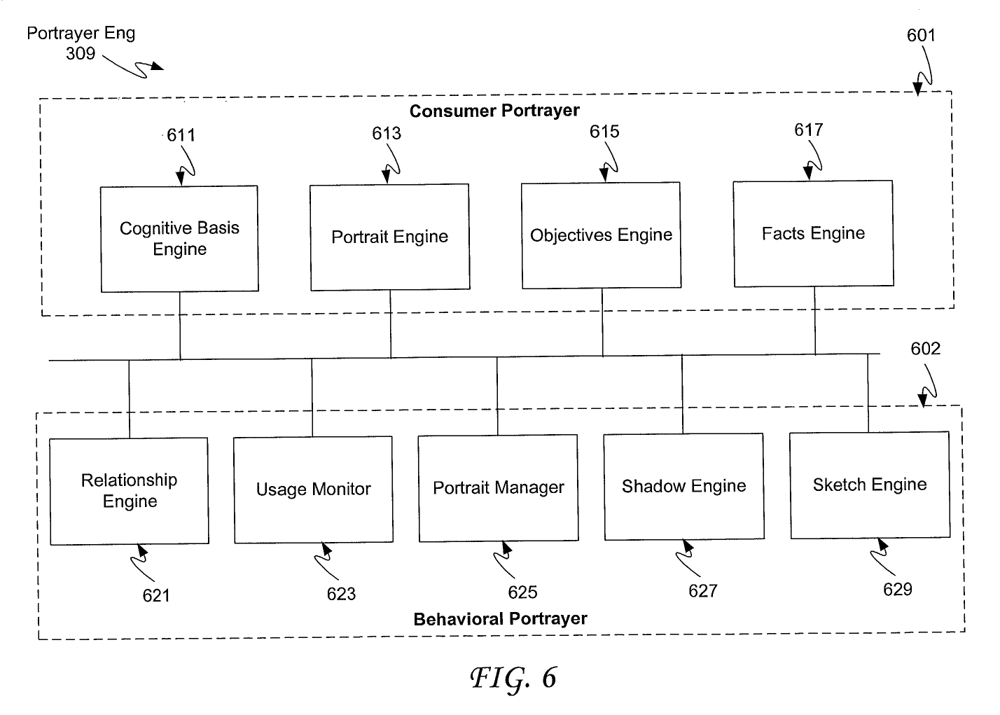

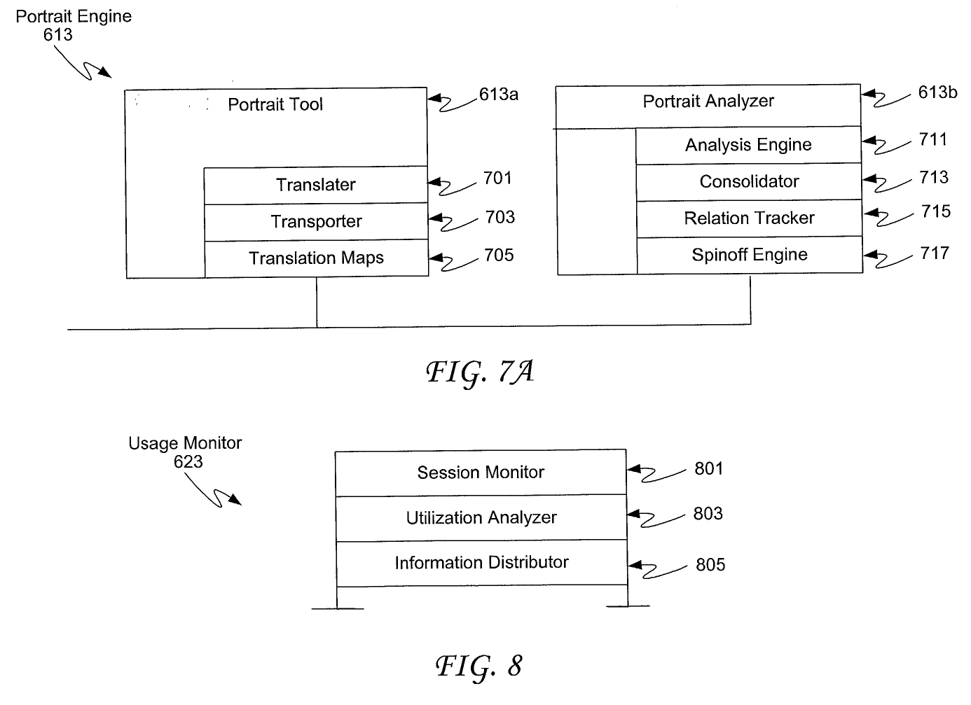

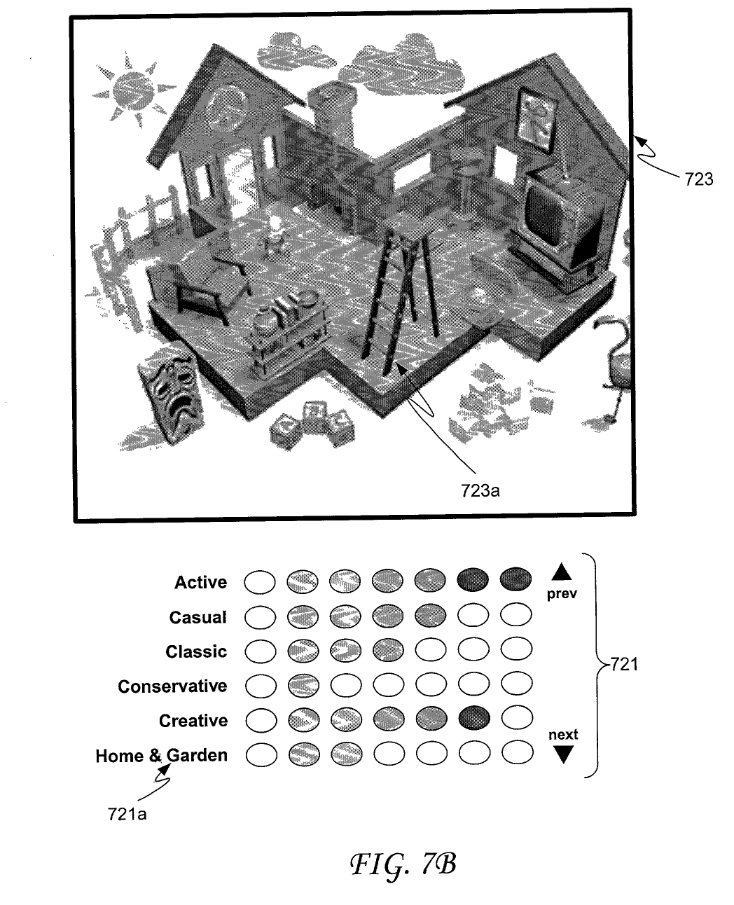

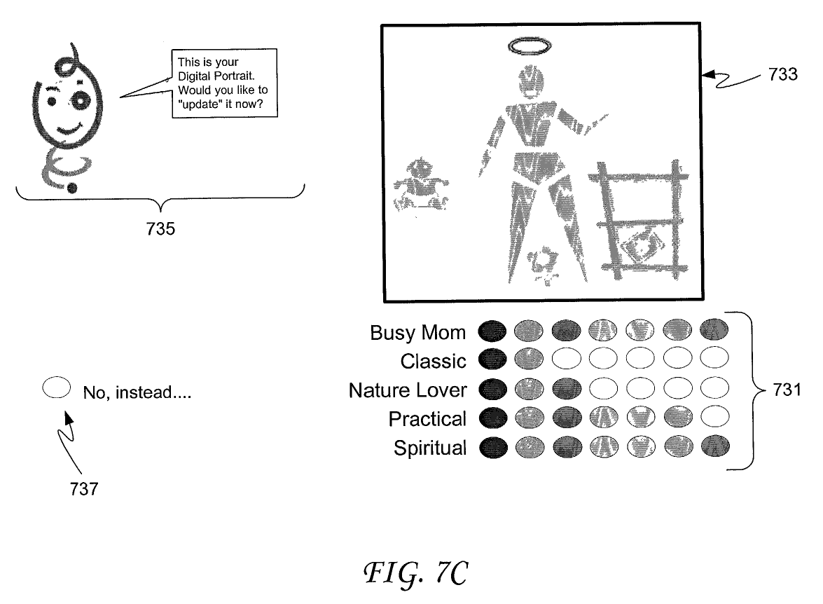

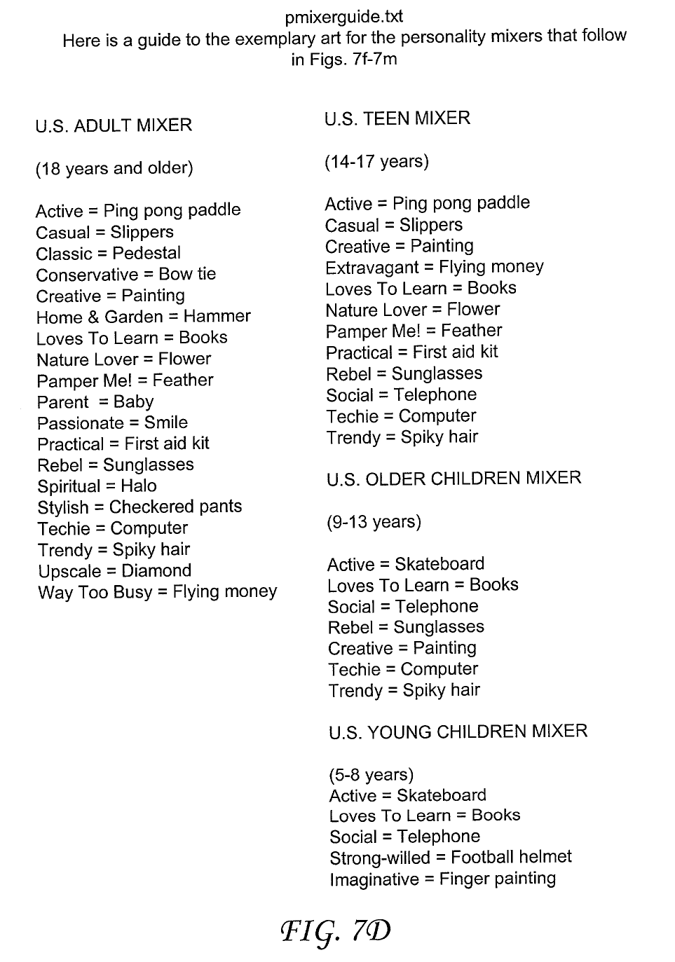

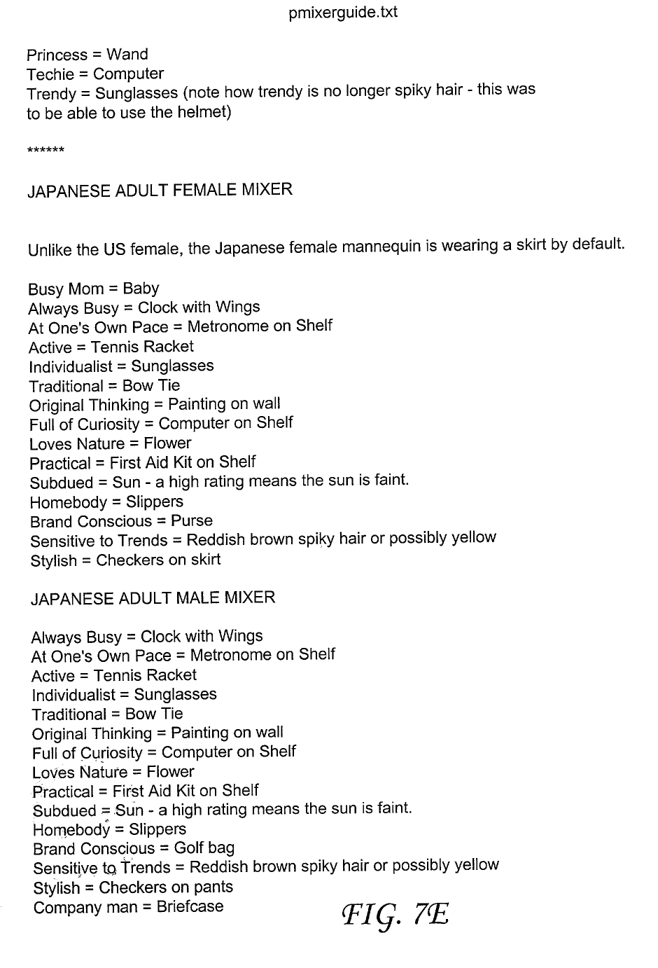

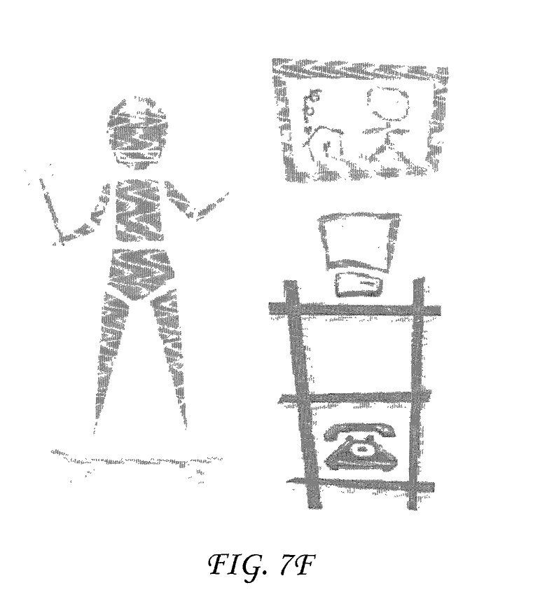

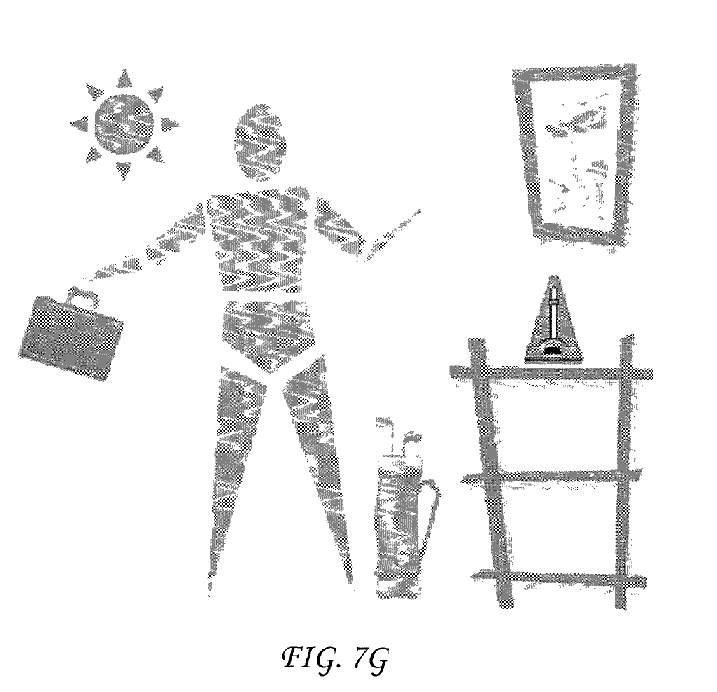

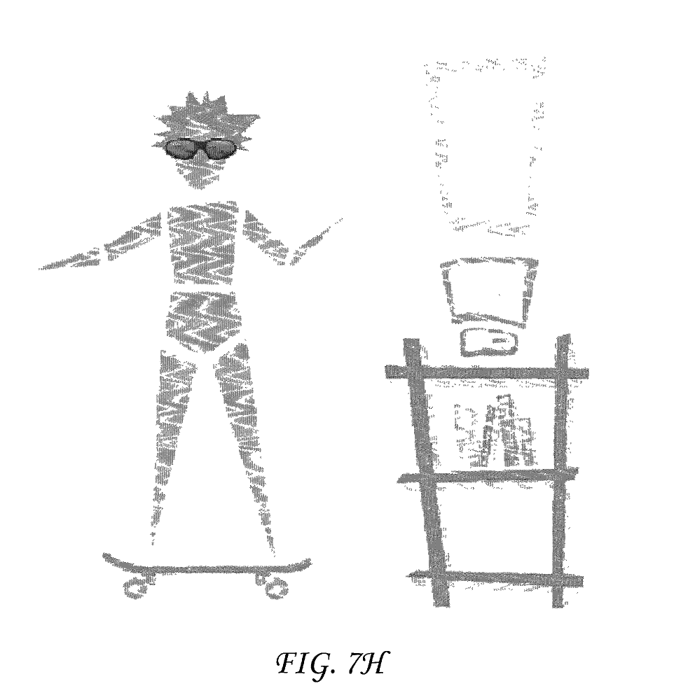

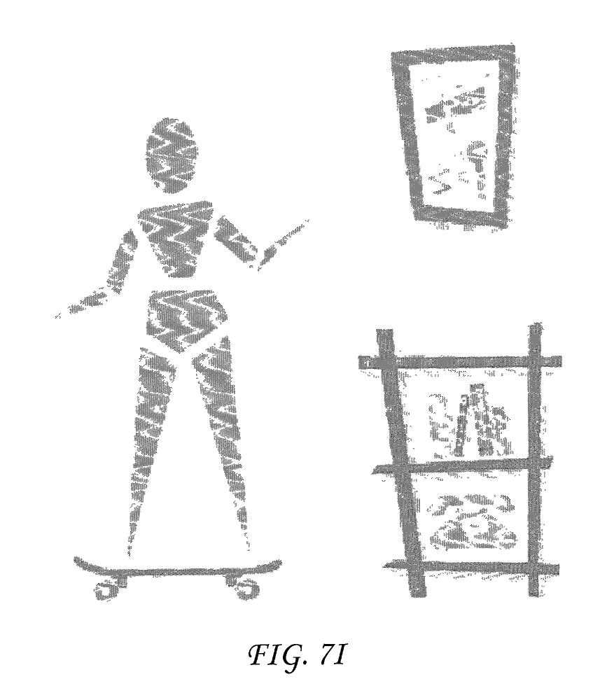

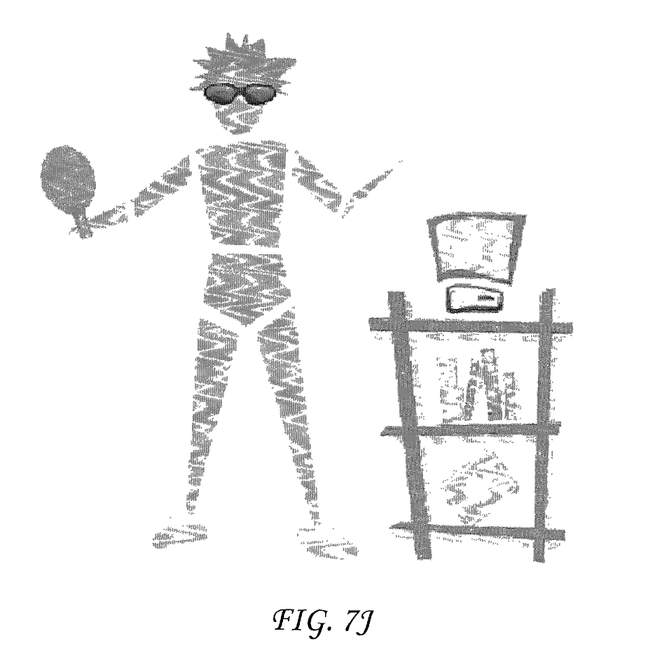

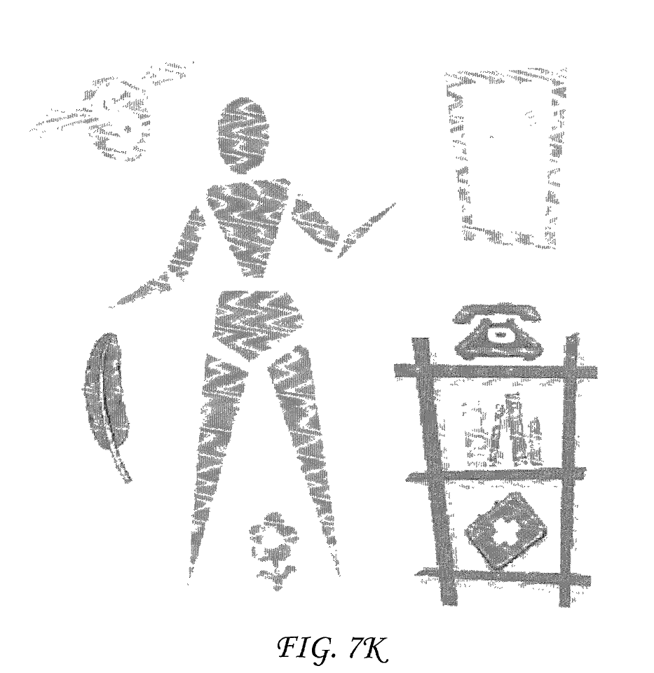

FIGS. 6 and 7a-c illustrate examples of the portrayer engine 309 embodiment of FIG. 5 in greater detail. Beginning with FIG. 6, portrayer engine 309 comprises a consumer portrayer 601, which provides for determining and modifying the aforementioned consumer cognitive and factual information, and behavioral portrayer 602, which provides for modification of the inferences that might otherwise be drawn by the matching-system from an initial single consumer self-portrayal. Portrayer engine 309 further includes cognitive basis engine 611, portrait engine 613, objectives engine 615 and facts engine 617, and behavioral portrayer 602 includes relationship engine 621, usage monitor 623, portrait manager 625 and sketch engine 629.

Within consumer portrayer 601, cognitive basis engine 611 and portrait engine 613 provide for creating and modifying consumer portraits, and more particularly, for determining cognitive bases and cognitive aspects corresponding to the cognitive bases, and a consumer portrait corresponding to the cognitive aspects respectively.

A consumer portrait includes a set of cognitive aspects (“cognitive aspect set”) that is found, when a weight is assigned to each aspect, to accurately portray an individual (e.g. a consumer) with regard to his more likely product predispositions. A default valued, self-assessed or consumer-assessed-for-another consumer portrait is currently formed and modified as needed for the consumer and every other person known by the matching-system to be associated with or “related to” a consumer. Additional consumer portraits are also determinable as associated with more specific consumer articles or other factors, such as with respect to a consumer's home, car, clothing, pet, etc.

(Default aspect or weighting values can, for example, be formed for new consumer contacts or others for whom little is known by the matching-system as an average of existing portraits having common “bases” or other aspects. Cognitive aspects can further be modified for default or other portraits based on corrections to suggestions, explicit entry or other information as might be inferred or otherwise determined by the matching-system.)

While susceptible to modification, subsets of the cognitive aspect superset illustrated in Charts 1a-c (below) are found to provide a sufficient combination of manageability and accuracy across varying matching-system servers in conjunction with the Personal Genie implementation. That is, each internally maintained Personal Genie consumer portrait currently includes a weighted combination of cognitive aspects (referred to hereinafter as “personality” aspects) among those listed in Chart 1. (The accuracy achieved by the Personal Genie implementation, when measured as the number of product matches corresponding to a consumer-user's stated actual product selections, was found to be up to seventy percent or more.)

Note that personality aspects are also utilized in at least initially determining consumer objectives, in forming product/vender portraits and in performing matching. While other consumer objectives might be utilized in a particular embodiment, consumer objectives will be referred to hereinafter as including consumer “intent” (i.e. relating to the consumer's current or future expressed or system-determined interests, objects, desires, or wishes) and consumer “long-term interests” (i.e. those cognitively and/or factually portrayed product types, categories, classes or genres (e.g. “science fiction”), etc. in which a consumer generally is and will likely continue to be interested for an extended time period). Product objectives are also similarly defined as including product intent and product long-term interests (e.g. from the perspective of one who might fulfill a wish with regard to each product).

[image]

[image]

CHART 1b
Example Personality Aspect Setting and stored offset

| US | | |
|---|---|---|
| Adult | User set | System Modification |
| Female | Values | Offset |
| Active | 10 | −2 |
| Busy Mom/Dad | 2 | 4 |
| Casual | 3 | −4 |
| Classic | 6 | −1 |
| Conservative | 0 | 3 |
| Creative | 2 | 0 |
| Extravagant | 5 | 0 |
| Home & | 9 | 0 |
| Garden | | |
| Loves To Learn | 8 | 0 |
| Nature Lover | 5 | 0 |
| Pamper Me! | 5 | 0 |
| Passionate | 2 | 0 |
| Practical | 0 | 0 |
| Rebel | 1 | 5 |
| Spiritual | 6 | 3 |
| Stylish | 4 | −1 |
| Techie | 8 | −5 |
| Trendy | 5 | 1 |
| Upscale | 2 | 0 |
| Way Too Busy | 10 | 0 |

CHART 1c
Example of integrated Translation Map for Intent “To unwind
after ‘one of those days’” versus Personality, Age and Sex

| US | To unwind after “one of those days” |
|---|---|
| Active | 0 |
| Busy Mom/Dad | 2 |
| Casual | 0 |
| Classic | 0 |
| Conservative | 0 |
| Creative | 0 |
| Extravagant | 0 |
| Home & Garden | 0 |
| Loves To Learn | 0 |
| Nature Lover | 0 |
| Pamper Me! | 2 |
| Passionate | 1 |
| Practical | 0 |
| Rebel | 0 |
| Spiritual | −1 |
| Stylish | 0 |
| Techie | 0 |
| Trendy | 0 |
| Upscale | 0 |
| Way Too Busy | 5 |
| 0-23 Month | −10 |
| 24-59 Months | −10 |
| 5-8 Years | −10 |
| 14-17 Years | −4 |
| 18+ Years | 0 |
| Being Female | 0 |
| Being Male | 0 |

A particular consumer portrait need not, however, include all of the personality aspects listed in Chart 1. Experiments conducted in accordance with the Personal Genie implementation, for example, indicate that a particular set of aspects and the manner in which a consumer will likely interpret and weight (or “rating”) of a particular personality aspect will vary in accordance with various “cognitive bases”. Suitable such bases have thus far been found to include age, gender and culture (examples of which are shown in Chart 1). Chart 1a also shows how the particular icons used in presenting a personality aspect (e.g. wording or other indicators) further tend to be interpreted differently in accordance with particular cognitive bases (such as for American versus Japanese, adult versus child or male versus female consumers). Consumer portrayer 601 therefore provides for presenting different icons in accordance with different consumer cognitive bases. (Finer distinctions, such as by more specific regional, cultural or other bases have thus far been found to be too resource intensive for the variety of computational or other matching-system implementation aspects that might be used.)

It should also be noted that the manner in which even an appropriate personality aspect set is presented for evaluation can also impact a consumer's reaction, and thus, the accuracy of the consumer information and resulting consumer portrait. For example, even ignoring culture and gender, an adult consumer who was rating herself tended to become insulted when presented with an aspect set with a rating scale measured from a “negative” description to a “positive” one, and was more comfortable with a rating scale from zero to some maximum value of a positively or neutrally expressed rating. However, the same consumer was found to be more comfortable rating her child from, for example, sleepy to fussy. Consumer portrayer 601 therefore provides for presenting different weighting icons (e.g. measurement scales) in accordance with different consumer cognitive bases.

The offset criteria depicted in Chart 1b is further provided for performing matching-system originated modifications of a user portrait. As will become apparent, a user portrait can be bi-directionally linked to a user profile presented to a consumer, thereby enabling modifications to one to be reflected in the other. It is found, however, that presenting matching-system modifications to a consumer (e.g. based on mis-matching of products) can be disconcerting to the consumer who might presume that she understands her personality. Therefore, portrait engine 613 provides for separately storing and functionally combining the offset with a corresponding personality aspect weight as needed (e.g. by simple addition), but without displaying the offset effect to a selectable one or more (e.g. all, a group, etc.) consumers or matching-system administrators.

Operationally, cognitive basis engine 611 determines cognitive bases from known or otherwise ascertained information, or by requesting such information from the consumer (as to himself or another). Cognitive basis engine 611 can, for example, poll survey, registration or other information that might reside on a consumer device or that might be available from a subscribing product vendor. Cognitive bases or an inference as to cognitive bases might also be drawn from a cognitive analysis of these or other informational sources that can be presented as a confirmable or correctable suggestion to the consumer. The location or setup of a particular device can also provide such information (e.g. determining culture based on the location of a kiosk in a particular country or region, or age, sex or other bases according to a business or affiliation location). Alternatively or in conjunction therewith, cognitive basis engine can also provide via the consumer device a suitable data entry form from which the appropriate information can then be returned (e.g. see above).

Turning now to the more detailed portrait engine embodiment of FIG. 7a, a suitable portrait engine 613 includes a portrait tool 613 for determining personality aspects corresponding to a cognitive basis, and further determining a consumer personality profile and translating the personality profile into a consumer portrait. Portrait engine 613 also includes a portrait analyzer 613b for tracking, comparing, combining and modifying consumer portraits.

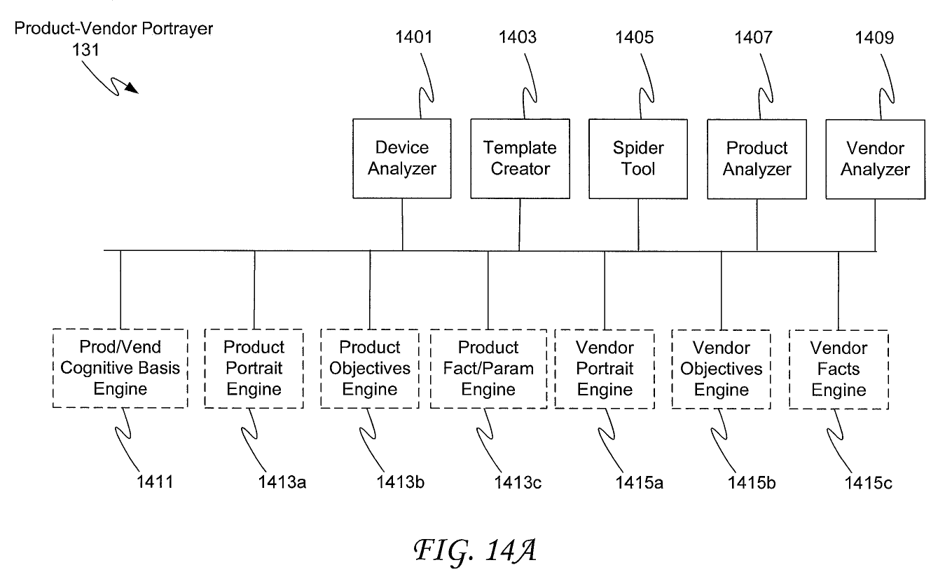

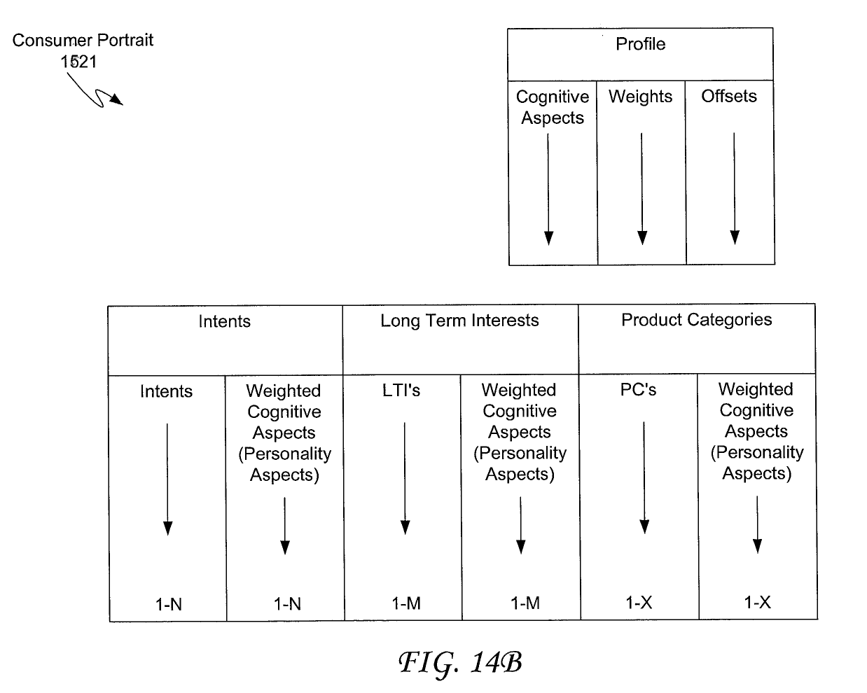

As shown, portrait tool 613a includes a cognitive translater (“translater”) 701 for determining/maintaining personality aspects and a personality profile, a transporter 703 for providing a consumer interface, and translation maps 705 for providing translations. Translater 701 receives from cognitive basis engine 611 of FIG. 6 a cognitive basis and determines, by polling translation maps 705 (via a request to management engine 313 of FIG. 3), personality aspects and weighting parameters corresponding to the cognitive basis. (An example of a suitable translation map is depicted by the above Chart 1c with respect to age and culture examples. More complete separate or integrated translation maps, e.g. stored in a multi-dimensional database, lists, or other suitable data structures, include a predetermined mapping of each cognitive basis combination to a personality aspect set (e.g., see FIG. 14b). Translater 701 can also perform polling in accordance with and translation maps can also include relationship or other parameters that might apply (e.g. a parent-assessment of a child versus a child's assessment of himself).

(While the translation and other Personal Genie maps and datasets were created via testing by behavioral psychologists, it will be appreciated that a suitable knowledge base or other so-called “artificial intelligence” tools might also be utilized for map or dataset creation or modification.)

Transporter 703 receives from translater 701 and provides to a consumer device-user a suitable interface for interactively assessing consumer personality aspects. As discussed, transporter can provide a suitable interface in accordance with a particular environment (e.g. the Personal Genie assistant environment), consumer device or other implementation considerations. Transporter 703 can also utilize selected device or user interfaces respectively from interfacer 501 and interface store 513 of FIG. 5 for providing the interface to a particular consumer device.

FIGS. 7b and 7c, for example, illustrate particularly useful interfaces usable by transporter 703 for enabling a consumer to create or modify a user profile. In the (home-oriented) profiling interface of FIG. 7b (e.g. which can be produced as already discussed), a consumer is presented with personality selector 721 for assigning weights to a personality aspect or modifying an existing personality aspect weight, and a personality profiler (or “snapshot”) 723 for providing an interactive feedback as to applicable personality aspects and weights. In this case, both of personality selector 721 and personality profiler are graphic.

More specifically, personality selector 721 provides a singular shape and color variable array, wherein a particular shape portion “lights” or dims in a color corresponding to the weight a consumer applies to a personality aspect (e.g. by pointing). Personality profiler 723 further transforms in accordance with an increased or decreased weight assigned by a consumer to a personality aspect by accentuating or subduing a corresponding personality aspect representation (in this case, a 3-dimensional graphic). (The home and garden aspect 721a, for example, corresponds with the ladder representation 723a in this case.) Transporter 703 thus provides to a consumer via a combination of personality representations and weight control representations a complete interactively modifiable personality profile corresponding to the consumer during self assessing, or to another person during assessment of another.

The FIG. 7b interface has been found to be particularly useful in creating a non-threatening if not amusing mechanism desirably inducing consumers to want to create additional portraits in conjunction, for example, with a PC or sufficiently graphically enabled PDA. It will be appreciated, however, that either or both elements might also be presented in other ways (e.g. using shapes, translucency, color, hue, orientation, etc.) and that one or more media or other perceivable sensory indicators, such as video, varying musical melody, harmony rhythm or contrapuntal elements, speech, virtual/augmented reality elements, texture, etc., might also be utilized in accordance with a particular device, desired effect or other implementation considerations.

FIG. 7c illustrates a further interface that might be utilized for (self/other) personality profile creation or, in this case, modification. Elements similar to those of the FIG. 7b interface have been retained for greater clarity, such as a similar personality selector 731 and personality profiler 733 (which is now 2-dimensional and more suitable to a less graphically capable consumer device).

However, transporter 703 of FIG. 7a also provides, in the FIG. 7c interface, similarly producible elements, including an exemplary assistant facilitated environment example (e.g. a “Genie” assistant provided by environment generator 505 of FIG. 5) and a further suggestion-based interfacing example (e.g. provided by suggestion engine 509 of FIG. 5). Transporter 703 further provides for receiving either user personality aspect modifications via personality selector 731 or a contrary user decision (i.e. via a response panel 737 selection) to utilize one or more other matching-engine services. (Transporter 703, upon receiving a response panel selection, causes a corresponding message to be transferred to an appropriate matching-system element via control unit 303 of FIG. 3, resulting in a further corresponding presentation.) It will be appreciated that a response panel selector indicating a consumer desire to modify a current personality profile might also be included as a pre-cursor to enabling personality profile modification.

Turning again to FIG. 7a, a portrait analyzer embodiment corresponding to FIG. 6 is illustrated Portrait analyzer 613b comprises an analysis engine 711, a consolidator 713, a relation tracker 715 and a spinoff engine 715. Analysis engine 711 provides for responding to received consumer portrait modifying information (e.g. resulting from a user suggestion correction, express modification, etc., typically via usage monitor 623 of FIG. 6) by analyzing the modification, determining a corresponding consumer portrait aspect and modifying or “updating” the aspect or weight assigned thereto.

Of the remaining portrait analyzer 613b elements, consolidator 713 provides for consolidating or “combining” multiple self-portraits created by the same consumer and for combining consumer portraits of other consumers to provide default consumer portrait weights or to provide suggestions to a consumer (e.g. to suggest products of other consumers having similar consumer portraits). Relation tracker monitors or “tracks” a consumer's relationship to other consumers (via messaging with relationship engine 621), as is discussed in greater detail below. Note that the Personal Genie implementation utilizes a weight scale of from 1 to 10 for personality aspect profiling and −10 to +10 in other cases; other weighting schemes can, however, also be utilized. Finally, spinoff engine 717 provides for releasing a portrait from a consumer's portrait store or “private gallery” for use by another; spinoff engine, for example, enables a consumer having created a portrait for her child to “spin off” the child portrait to the child when the child reaches sufficient maturity or receives a credit card so that the child, rather than the parent-consumer, can conduct its own shopping.

Returning now to FIG. 6, objectives engine 615 of consumer portrayer 601 provides for determining and modifying consumer objectives (such as intent and long-term interests, as used in the Personal Genie). Operationally, objectives engine 615 determines initial objectives by comparing a consumer's product portrait personality aspects and weighting to a cognitive personality aspect combinations-to-objectives mapping (via a request to management engine 313 of FIG. 3). Objectives engine 615 further, upon determining a correspondence between the consumer portrait and mapping, causes a copy of the corresponding mapping objectives to be stored as the consumer's initial objectives. (The mapping is once again predetermined in accordance with behavioral psychologist testing, but might also be determined utilizing a suitable knowledge base or other artificial intelligence tools.) Objectives engine 615 also provides for modifying a consumer's objectives in accordance with consumer correction of suggestions and/or other matching-engine ascertained consumer objective affecting information.

Finally, facts engine 617 of consumer portrayer 601 provides for determining and modifying consumer facts (e.g. sizes, color preferences, etc.) by receiving explicit consumer input, suggestion corrections and/or other ascertained consumer information, determining whether the fact type or types for such information correspond with one or more predetermined fact type parameters, and if so, causing fact indicators corresponding to the fact information to be associated with the consumer's consumer information.

Continuing with the lower portion of FIG. 6, an exemplary behavioral portrayer 602 of portrayer engine 309 includes relationship engine 621, usage monitor 623, portrait manager 625, shadow engine 627 and sketch engine 629.

Relationship engine 621 provides for determining and modifying relationship indicators indicating one or more relationships of varying strength between a current consumer and other consumers, (or other persons or groups) and communicating the relationship information to relation tracker 715 of portrait engine 613 (FIG. 7a). Relationship engine 621 determines that a relationship exists or has been modified in accordance with received explicit consumer input, suggestion corrections and/or other matching-system ascertained consumer information. (Note that relationships can vary widely and can include familial or household relationships (e.g. parent, child, spouse, etc.) as well as companions, friends, enemies and business contacts, among others.)

Note also that by creating at least a default value portrait for each contact (see below) and further monitoring and modifying contact information on an ongoing basis, matching-system 100 enables accurate and pertinent wish-fulfillment that takes into account consumer objectives, cooperative endeavors and effects on others. Matching engine 311 (FIG. 3) can, for example, utilize currently pertinent relationships and corresponding portraits in performing more pertinent matches (e.g. suggesting a suitable restaurant or travel, setting aside “quality time”, coordinating smart home devices, purchases, gifts, parental controls, etc.).

Referring also to the more detailed embodiment of FIG. 8, usage monitor 623 provides for monitoring and facilitating of matching-system element updating in accordance with matching-system utilization and non-use by or on behalf of a consumer. Session monitor 801 (FIG. 8) receives from security engine 319, matching engine 311, transaction engine 317 and other matching-system elements (typically via control unit 303 (FIG. 3) messages indicating when a consumer has accessed the matching-system, and with regard to the time and nature of the consumer use (e.g. matching, purchasing, scheduling, etc.), and communicates such information to utilization analyzer 803. Session monitor 801 further polls a matching-system maintained consumer message list and any stored application-specific information and also communicates such information to utilization analyzer 803. (Monitored information can, for example, include explicit or implied consumer indications of their product likes or dislikes, product selections, product use or purchase and products selected for a consumer's wish, anti-wish or gift lists.)

Utilization analyzer 803 analyzes the received information and determines therefrom statistical information (e.g. overall use of the matching-system, viewing of specific vendor products etc.). Utilization analyzer 803 also determines whether the received information indicates that a matching-system element or information requires updating, and communicates the determined results to information distributor 805. Information distributor 805 identifies the managing matching-system element for each received determination and communicates the information (typically via control unit 303 of FIG. 3) to the corresponding managing element.

Utilization analyzer analysis might, for example, reveal inaccurate suggestions (e.g. in accordance with a consumer correction instance), the results of which might, if sufficiently continually inaccurate, be communicated to product engine 613, objectives engine 615 or facts engine 617 for modifying consumer portrait, objectives or facts respectively); however, isolated instances might simply be stored. A matching-system administrator might also be notified. Analysis might also reveal that certain information is sufficiently outdated and no longer viable; for example, a meeting date that has already passed (e.g. in accordance with a calendaring application) might be deleted or added to a “for deletion list” reviewable by one or more consumer participants. No longer pertinent consumer messages in a maintained consumer messages list might also be similarly “deleted.” Unavailability of appropriate products or information relating to a new transaction event might further be added to the consumer messages list, among other possibilities.

Of the remaining consumer portrayer engine elements of FIG. 6, portrait manager 625 provides for tracking of the various consumer portraits that might be created in addition to the base consumer portrait discussed thus far. While the base consumer portrait has been found to produce matching results having up to seventy percent or greater accuracy (i.e. in selecting pertinent products), additional portraits have also been found to provide even greater accuracy with regard to more specific wish fulfillment. A consumer might, for example, create additional self-portraits portraying their “personality” with regard to their car, home, clothing, travel or other more specific scenarios. Other consumers might further utilize silhouettes or “sketches” of consumer portraits (see below).

Portrait manager 625 receives portrait/sketch creation or modification messages from usage monitor 623, portrait manager 613 or sketch engine 629 and provides portrait list information to matching engine 303 of FIG. 3 (e.g. for separate or typically consolidated use during matching), interface engine 307 (e.g. for express consumer creation, additions or modification) or other matching system elements.

Shadow engine 627 provides for creating and maintaining shadow or “shadow list” information that operates as a template or set of (initially) default values for product portraits and product parameters. Shadow engine 627 is more specifically invoked by control unit 303 (FIG. 3) upon execution of a new application by a consumer. (A default shadow template is provided in the Personal Genie for each consumer with regard to each application.)

Parameters can, for example, include a reliability factor from viability engine 315 indicating how likely a product is to be a member of a list or an importance factor indicating whether one or more consumers should be notified/queried or automatic operation can be employed. Parameters can also include a multiple products parameter indicating that an associated product can be combined with one or more other products within a “container”, such as during a time interval, place, product, product-service or other combination (e.g. food in a pantry, item in a room, car or office, items and servicing for a construction project or travel, etc.). Note, however, that a shadow is treated as a view into a list (such as a product portrait) and thus inherits the natural order of a list being “shadowed” (e.g. activities over time; items in a pantry by grocery store aisle, if otherwise utilized and known; etc.).

Shadow engine 627 further modifies the shadow list in accordance with information messages that it receives in accordance with application operation (e.g. via application engine 305 of FIG. 3), matching (e.g. via matching engine 311 of FIG. 3), viability engine 315 or other matching system element operations, and in accordance with shadow “rules” or “filters”. Shadow rules provide operations and metrics for adding, removing or modifying elements or parameters (e.g. reliability), typically using a shadow and a portrait as arguments and returning, as a result, the modified shadow.

Finally, sketch engine 629 operates in conjunction with security engine 319, matching 311 and other matching-system elements to provide for creating and maintaining consumer portrait or list “sketches” (i.e. views into or “re-uses” of a portrait or list). That is, sketch engine 629 enables one or more secondary consumer-users with appropriate permissions from a first consumer to re-use or even modify essentially a “copy” of a first consumer portrait or list. (The copy can, for example, comprise an actual copy or utilize the original with an appropriate “user indicator” and recordation of any changes that is associated with each secondary consumer-user, as with the Personal Genie implementation.)

Upon a request by the secondary consumer-user to utilize a first consumer portrait/list (e.g. having selected a consumer from a matching-system interface engine supplied consumer list), sketch engine 629 causes a message, such as an email or a message within the environment, to be sent to the first consumer for permission. Permission can be granted with respect to selectable aspects of a portrait/list or to varying extents, which can be applied to the sketch by way of consumer or group based use permissions or “filters”. (A first consumer can also initiate assignment of sketch “rights” to one or more users or groups, that can be similarly notified.) In the Personal Genie, for example, filters can range from full manipulation (enabling modification or deletion) to different manipulation of different aspects, to nullity (where the source portrait/list does not appear to others to exist); the relation between the sketch and the portrait is further encrypted (see below), such that the sketch can only be viewed or otherwise utilized by those authorized, and while such authorization is provided. (The first consumer can also similarly alter rights or complete authorization with regard to one or more secondary consumer users/groups).

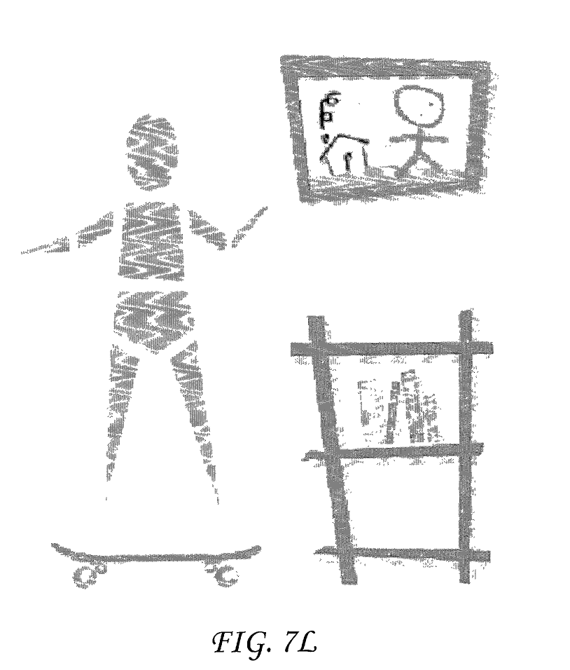

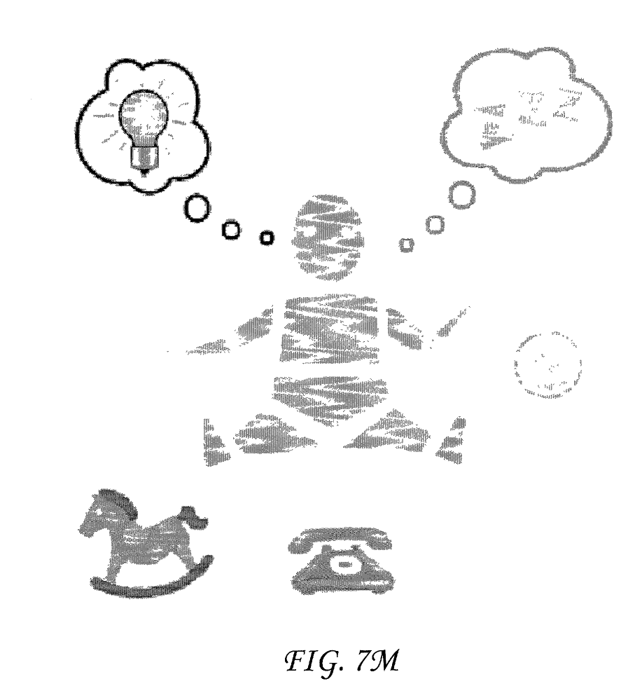

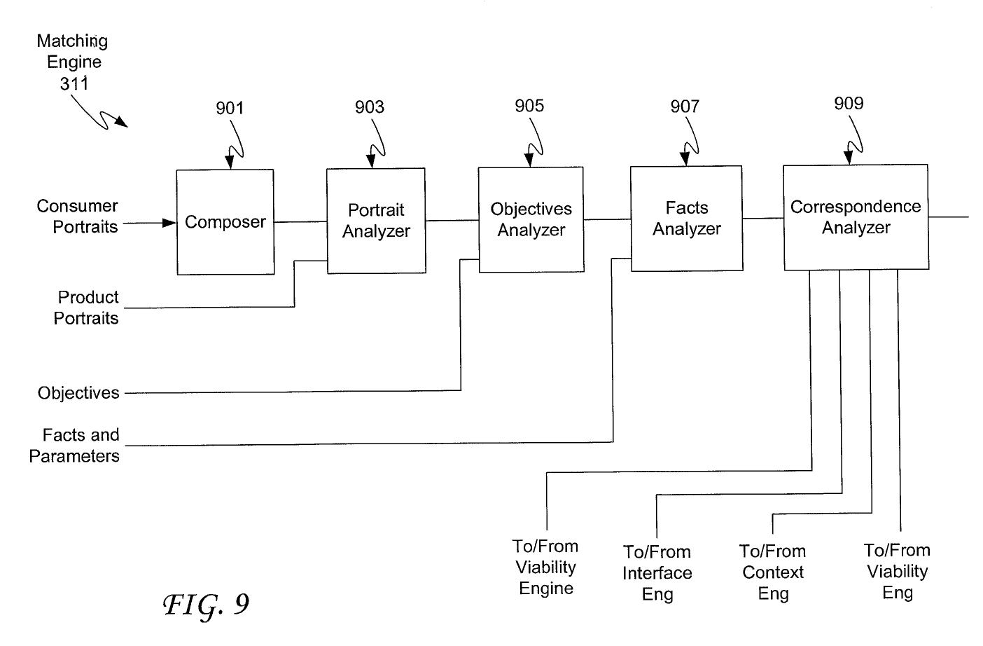

Returning now to FIG. 3 with reference to FIGS. 9-13c, the remaining elements of the depicted wish engine 111 embodiment (FIG. 3) will now be discussed in greater detail, beginning with the matching engine embodiment detailed in FIG. 9.

FIG. 9 illustrates how matching engine 309 includes composer 901, portrait analyzer 903, objectives analyzer 905, facts analyzer 907 and correspondence analyzer 909. Upon receipt of a matching request for a consumer, composer 901 receives via control unit 303 (FIG. 3) and combines or “consolidates” all applicable consumer portraits for the consumer, group or others for which the matching is being conducted. (The Personal Genie implementation utilizes a simple averaging; however, any suitable function or functions found to result in sufficiently accurate matching can also be utilized.) All consumer portraits for the consumer (and any other applicable persons) might be utilized or a subset might be utilized, for example, where a consumer portrait is directed at a particular and irrelevant product type. Composer 901 then communicates the consolidated results to portrait analyzer 903.

Thereafter, portrait analyzer 903 determines, by issuing a request to management engine 313 (FIG. 3), all product portraits having personality aspects and weights sufficiently corresponding to the received consolidated consumer portrait, and further receives and forwards corresponding matching product indicators to objectives analyzer 905. Objectives analyzer 905 receives, in addition to the matching product indicators, objectives information for the consumer, and determines (via a request to management engine 313), all indicated products whose objectives further sufficiently correspond to the consumer objectives. Objectives analyzer 905 further communicates objectively matching product indicators for all objective-corresponding products to facts analyzer 907.

Facts analyzer 907 receives, in addition to the objectively matching product indicators, all indicated products whose parameters sufficiently correspond with applicable consumer facts (via management engine 313) and forwards the product indicators for the remaining products to correspondence analyzer 909.

Correspondence analyzer 909 receives, in addition to the remaining product indicators, any further applicable product parameters (e.g. product relevance parameters indicating a relevance weight and reliability found to exist for the weighting for each personality aspect combination) and any application or context constraints that might apply. Correspondence analyzer 909 further determines, of the remaining products, those products that sufficiently correspond to these remaining constraints and orders any remaining product indicators according to their decreasing correspondence accuracy. Finally, correspondence analyzer 909 receives from viability engine 315 (FIG. 3) a maximum number of products to return and deletes the least accurately corresponding products in excess of that number.

It will be appreciated that while the particular messaging mechanism might differ (e.g. conducting composite polling via management engine 313, transferring varying consumer/product information at different stages, etc.), matching engine 313 provides a highly efficient and accurate matching system. Even with the above noted extensive cognitively and factually categorized product list (already numbering over 10,000 entries), consumer and product portrait correspondence analysis yields only about 5000 matching products. Objectives, factual and correspondence analyses can further pare the total number of products respectively down to about 50, 25 and 3-5 typically highly pertinent products.

It should also be noted that the same or similar processing is also conducted with regard to vendors (which can further be pared down in accordance with a negative feedback list, which might also be maintained), and with regard to product-vendor combinations. The “sufficiency” of the correspondence, which is determinable, for example, through the use of viability engine 315 (FIG. 3) or applicable product/vendor parameters, can also be adjusted in accordance with the desirability of assuring matches, the matching accuracy desired or found to exist, or other suitable factors.

Continuing with FIG. 10 with reference to FIG. 3, a suitable management engine 311 embodiment includes a data manager 1001, a communications manager 1003 and a system device/process interfacer 1005. Data manager 1001 provides for storing, polling and retrieving matching-system information from one or more local or external data stores. Communications manager 1003 further provides for communicating with any external data stores or facilitating the use of distributed such information, such as within differently located data stores, coordinator 104 or other devices. System device/process interfacer 1005 provides for executing applicable protocols relating to communications manager operation.

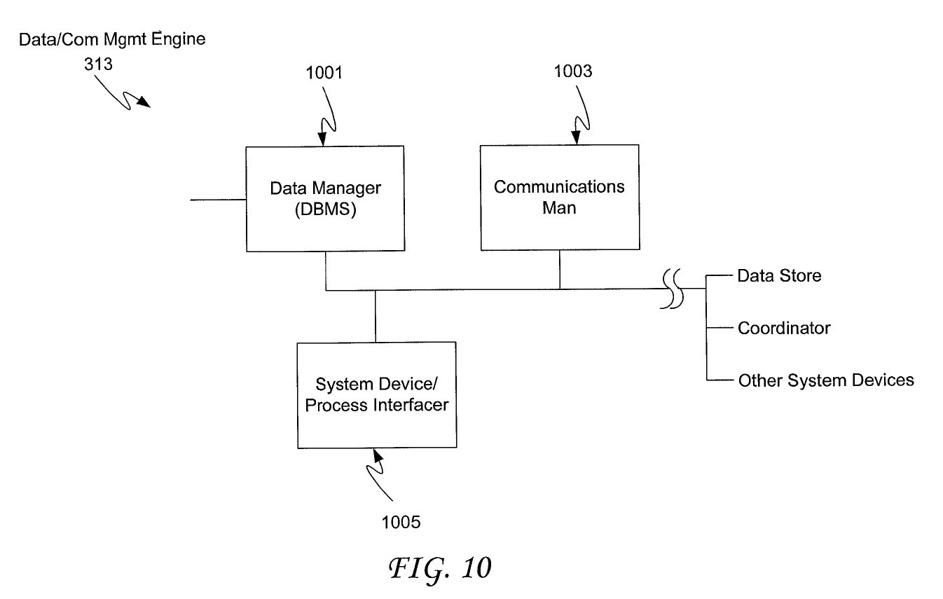

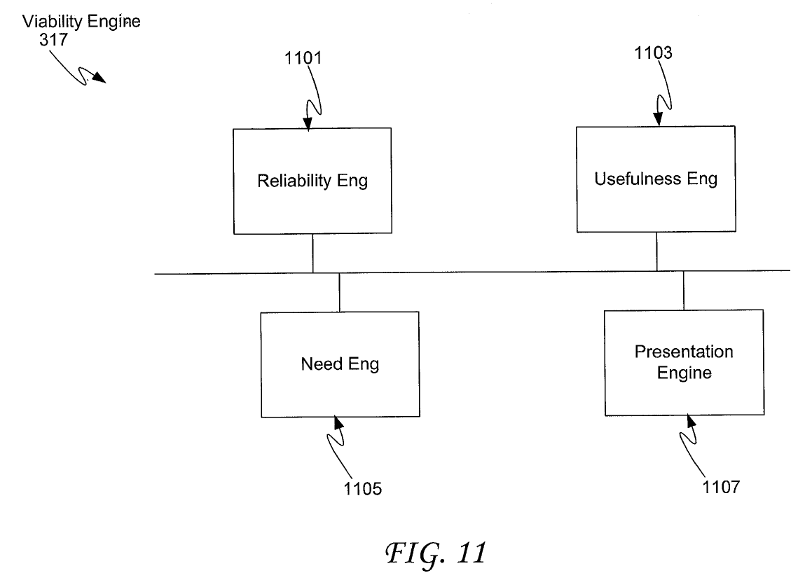

FIG. 11, with reference to FIG. 3, illustrates how a suitable viability engine embodiment includes a reliability engine 901, a usefulness engine 903, a need engine 905 and a presentation engine 907. Reliability engine 1101 responds to a request for verification by determining the reliability of information associated with the request. The reliability of received information can be determined with regard to only the received information or also with regard to other matching-system accessible information. Reliability engine 901 tests substantially all information received by the matching system and many of the results of matching system operation for reliability.

Typically, for example, the received information will include information that is inconsistent, such as where two location indicators indicate a first location while a remaining location indicator indicates a different, similarly probable location; in this case, reliability engine 901 would compare the information and determine that the first agreed upon location is more reliable. Other matching-system information can also be consulted, such as a GPS indicated location, cellular phone triangulation, a consumer-initiated smart appliance operation at a known location, scheduling, a home indicator while the consumer is traveling, gathered cognitive or factual information (e.g. using personality aspects to weigh a likelihood that an information condition exists, etc. The reliability of information can also be determined via rules, metrics, predetermined or “learned” parameters (e.g. via a suggestion correctness measure).

Usefulness engine 1103 provides for determining whether particular consumer, product, vendor or other matching-system information is no longer needed and should be removed from the matching-system (e.g. to a backup system or by deletion). Usefulness engine 1103 thereby enables the vast amounts of application, consumer, product, vendor, application, mapping, list and other information that might be stored and require management (e.g. searching or “polling”) to be monitored and pared. Operationally, usefulness engine 1103 periodically receives and compares consumer and vendor status and a stored period of non-use information record parameter with stored information parameters (e.g. including period of non-use and subscription status) and causes those records that are found to be no longer useful to be deleted.

Need engine 1105 responds to requests for testing whether additional information is desirable in order to provide a consumer or vendor with more pertinent information and, if so, causes the matching-system (via control unit 313 of FIG. 3) to obtain the information. While the suggestion-based interface provides a ready, user-friendly mechanism with which to obtain information from a user, it will be appreciated that a positive user experience is furthered by the largely automatic operation enabled by the matching-system. Therefore, while the need engine 1105 can be used to present a consumer with a request for further information, the need engine 1105 is used largely in conjunction with other sources of information accessible by the matching-system (see above).

Presentation engine 1107 provides for determining, from an amount of available information, an amount of information that will be presented to a consumer. Typically, presentation engine 1107 operates in conjunction with the above-discussed matching engine 311 (FIG. 3). In the Personal Genie implementation, for example, presentation engine 1107 operates in accordance with a presentation parameter (not shown) indicating to matching engine 311 a maximum number of products or vendors to provide to a user. Currently, a single parameter indicating a maximum of three products is utilized. It will be appreciated, however, that presentation engine 1107 can also be implemented in conjunction with a greater number or variety of parameters (e.g. based on particular products, vendors product categories, etc.); presentation engine 1107 can further be implemented to more generally control information flow, for example, to or from a consumer, vendor, device or process on an ongoing basis (e.g. in communicating successive blocks of information).

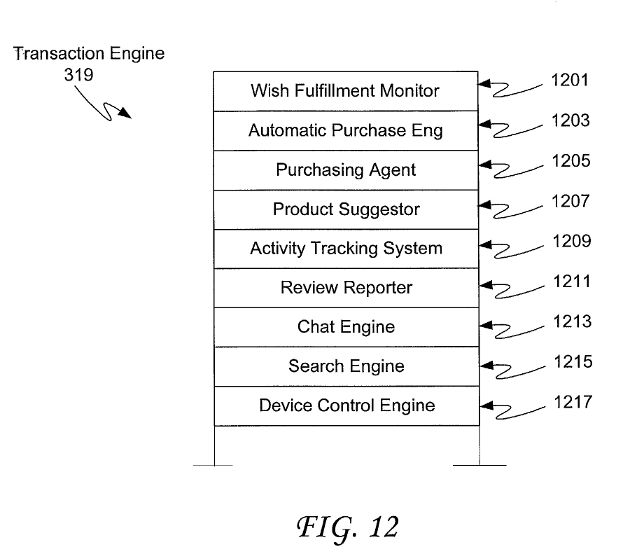

FIG. 12, with reference to FIG. 3, illustrates how a suitable transaction engine embodiment includes a wish fulfillment monitor 1201, an automatic purchase engine 1203, a purchasing agent 1205, a product suggester 1207, an activity tracking system 1209, a review reporter 1211, a device control tool 1213, a chat tool 1215 and a search engine 1217. Transaction engine 319 provides for conducting or facilitating actually or potentially multiple item tasks.

Within transaction engine, wish fulfillment monitor 1201 provides for tracking linked sequential, concurrent or composite transactions. Wish fulfillment monitor also provides for determining a transaction status and supplying or otherwise facilitating notifications to interested parties (e.g. consumers or vendors) with regard to a particular status (e.g. whether or not a status milestone has been achieved, a next step, etc.).

For example, fulfilling a vacation planning wish with an expressed consumer intent of “having a weekend getaway” might include suggesting a travel package; the travel package might further include, for example, airline tickets, car rental, hotel or restaurant reservations and theatre tickets, among others. In fulfilling this wish, matching engine 311 would find corresponding products to fulfill the wish and interfacing engine 307 (via suggestion engine 509 of FIG. 5) would present the corresponding products as consumer suggestions. Wish fulfillment monitor 1201 would further track each transaction, provide status notifications (to one or both participants per their expressed or historical preferences) and verify successful fulfillment of transactions and the entire wish.

Wish fulfillment monitor 1201 is also capable of similarly facilitating composite or sequential transactions involving two or more products. For example, a consumer might order a year's supply of pizza including 52 weekly orders for delivered pizza (i.e. a composite transaction “wish”). In this example, wish fulfillment monitor 1201 would track, report status notifications on and verify successful fulfillment of each order and the overall order “wish.” In fulfilling a sequential transaction wish, wish fulfillment monitor 1201 might, for example, facilitate a sequence of home remodeling products or subcontractor labor, or a sequence in which a consumer's alarm clock and a coffee maker are “wished” to go off in a particular timed sequence, among other examples.

Automatic purchase engine 1203 provides for purchasing products automatically without consumer intervention in accordance with a consumer portrait or in response to an explicit consumer request. For example, a consumer might request the matching-system to automatically select and purchase a gift for a person, persons or a group of people in the consumer's collection of portraits or “portrait gallery”. The consumer might further have specified a type of gift, price range and delivery date. Automatic purchase engine 1203 would, in this example, purchase a gift indicated by matching engine 211 and, upon sending the gift (or at some other predetermined time) notify the consumer (e.g. by email) as to the product name, cost and date of delivery.

Automatic purchase engine 1203 might further purchase one or more items according to a “when on sale” option or facilitate repeated purchases of items needing periodic replacement, such as food, clothing, shoes, software updates, filters, etc. Among other examples, automatic purchase engine is also capable of utilizing consumer facts (e.g. size, color, etc.) or ascertained facts (e.g. facilitating purchases in accordance with a particular time of year, such as purchasing special foods, materials, variants, etc.)

Purchasing agent 1205 provides for facilitating fulfillment of purchasing wishes that can include dependent transactions and substitutions. Purchasing agent 1205 more specifically responds to a consumer purchase selection or request for a product return by receiving from storage associated with the consumer (e.g. via management engine 313 of FIG. 3) consumer purchasing information, generating a transaction, ensuring that the transaction is validly conducted, and reporting transaction information to and monitoring status from wish fulfillment monitor 1201. Purchasing agent 1205 can further verify special intermediate product quality checks or “shipping TLC” or other special purchasing services.

Product suggester 1207 provides for suggesting to a consumer products having successfully fulfilled the wishes of other consumers having sufficiently similar personality aspects (or further similar objectives or fact information). Operationally, product suggester 1207 generates a polling request (via management engine 313 of FIG. 3) for purchases or other uses (e.g. testing) of products by other consumers having consumer portraits sufficiently similar to the consumer's (see above). Product suggester 1207 further compares the purchases to those products that the consumer has viewed, purchased or otherwise been exposed to and causes those products to which the consumer has not been exposed to be suggested to the consumer (via interfacing engine 307).

Of the remaining transaction system elements, activity tracking system 1209 provides for maintaining a matching-system usage history (e.g. a list, database, etc.) by recording consumer usage reported by usage monitor 623 (FIG. 8) and responding to matching-system element requests by providing such information. Review reporter 1211 provides for receiving and posting (e.g. on an electronic bulletin board) or further analyzing consumer comments as to products or vendors and providing therefrom product or consumer ratings. Chat tool 1213 provides for communication among matching system users via typing, file transfer, voice, video, graphics or other media. Search engine 1215 responds to a consumer request for a specific product by finding and returning the product (e.g. for use by one of transaction engine 319 elements or for presentation to a user). Finally, device control engine 1217 provides for matching-system control of consumer or other devices or processes in accordance with an explicit consumer request or as part of a presentation, typically by communicating a control sequence to interfacing engine 319.

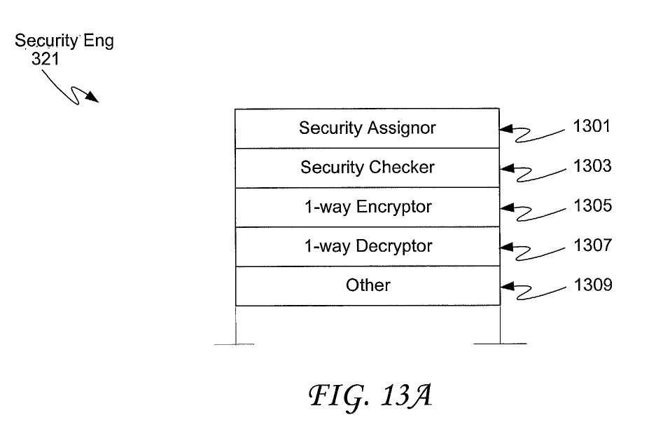

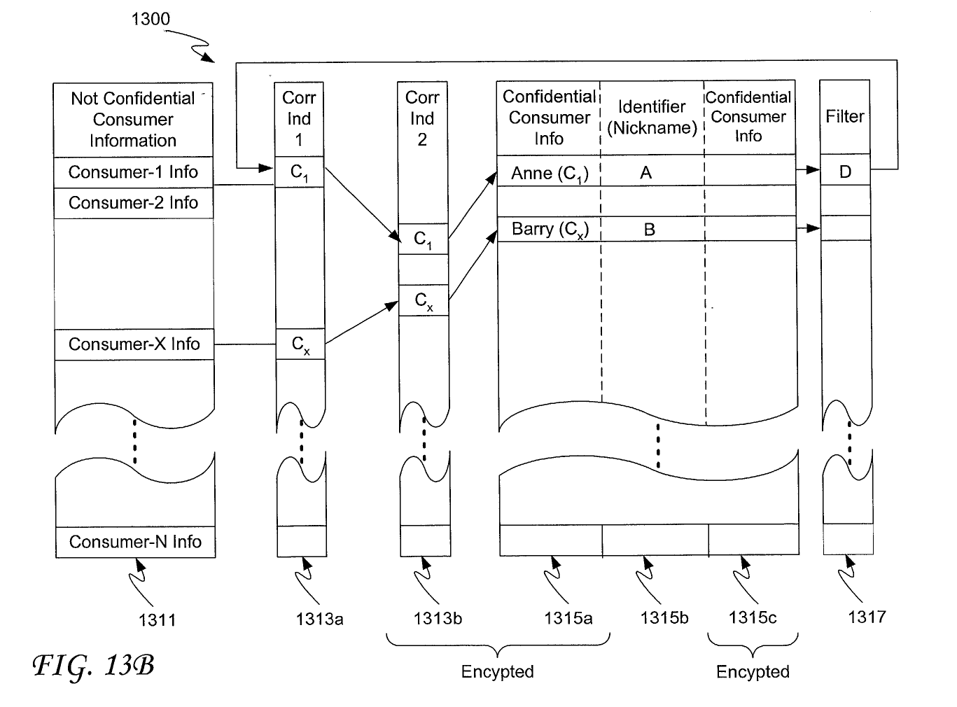

FIGS. 13a-b (with reference to FIG. 3) illustrate, in greater detail, a security engine embodiment according to the invention. Beginning with FIG. 13a, security engine 321 includes a security assignor 1301, security checker 1303, one-way encryptor 1305 and one-way decryptor 1307. (It will be appreciated that security engine 1305 can also include other security tools or protocols in accordance with a particular application or other implementation considerations.)

Security assignor 1301 provides for issuing to a new consumer a security code, and for issuing encryption keys to a new consumer or a consumer utilizing a another's consumer portrait. Security checker 1303 provides for authenticating a consumer when the consumer initiates use of the matching-system. One-way encryptor 1305 provides for encrypting portions of a consumer's information in a manner such that demographic or cognitive analysis can incorporate consumer information, but the consumer's identity and personal information can only be determined by successful authentication upon entering the matching-system. One way decryptor provides for enabling a successfully authenticated user to access a corresponding consumer's identity and personal information.

More specifically, when a new consumer logs onto the matching-system, security assignor 1301 requests consumer identification and, upon receiving such information, issues to the new consumer a username, password and encryption key for accessing encrypted consumer information. Security assignor 1301 further stores the encryption key with consumer information corresponding to the consumer. (The encryption key is formed from the consumer supplied information.) Thereafter, when the consumer logs onto the matching-system, the consumer enters the username and password, which security checker 1305 authenticates and, upon successful authentication, provides the consumer with access to the encryption key.

Turning to FIG. 13b, one-way encryptor 1305 causes the depicted consumer information data storage structure to be formed. The storage structure includes a cognitive and factual information portion 1311, a correspondence indicator portion 133a-b, a factual information portion 1315a-c and a filter portion 1317. One-way encryptor 1305 causes portions of the data structure data to be separately encrypted for each consumer including a second correspondence indicator 1313b, and factual information portions 1315a and 1315c containing confidential consumer information between which an unencrypted consumer identifier 1315b (e.g. a nickname, alias, etc) is interposed.

Since the ordering of the information in consumer information structure 1300 can vary and the above portions are encrypted separately for each consumer, the information in portions 1315a-c is accessible only by a user who enters the matching system normally, is successfully authenticated and obtains and uses the corresponding key. Correspondence indicator-1 1313a is aligned with consumer information in portion 1311 and includes a pointer to correspondence indicator-2 1313b with which its alignment can vary. Correspondence indicator-2 1313b further includes a pointer to corresponding consumer information in portions 1315a-c with which its alignment can vary; further, no pointers are provided to move from consumer information in portions 1315a-c via correspondence indicators 2 and 1 to corresponding consumer information in portion 1311. (One-way decryptor 1307 provides a consumer having access to an encryption key with access to portions 1315a-c by decrypting the corresponding consumer information using the key.)

FIG. 13b also illustrates how security assignor 1301 can enable a second consumer to revocably access or otherwise utilize a first consumer's portrait (i.e. to create or utilize a sketch), for example, to send the first consumer a gift. As shown, consumer information structure 1300 also includes filter records (e.g. within filter store 1317) corresponding to the consumer information of each consumer. When the second consumer requests access to the first consumer's portrait, security assignor 1301 causes a message to be sent to the first consumer reflecting the request and suggesting a particular filter option (e.g. ranging from no access to complete access and modification capability).

If the first consumer agrees, then security assignor places a second consumer indicator in the filter field of the first consumer's information and the corresponding key is made available to the second consumer; at this point, the second consumer is considered (with full permission) as equivalent to the first and can even affect the portrait by using the matching system. However, if security assignor 1301 receives a message that the first consumer has revoked her permission, then it removes the second consumer filter indicator and thus access to the key and first consumer portrait. (It will be appreciated that, while a sketch comprising a copy of the first consumer's portrait might also be used and then modified without affecting the first consumer, that such a method avoids the vast storage required for storing numerous portrait copies.)

FIG. 14a illustrates, in greater detail, the product-vendor portrayer embodiment 131 of the FIG. 3 wish server 101. As shown, product-vendor portrayer 112 includes a device analyzer 1401, a template creator 1403, a spider tool 1405, a product analyzer 1407 and a vendor analyzer 1409.

Device analyzer 1401 provides for automatically gathering information about the identity and functionality of an otherwise unknown networked device. Operationally, device analyzer 1401 gathers such information, upon being transferred to a device, by interrogating the network mechanism by which the device is controlled. For example, if a device registers itself with a network using a Jini protocol, then device analyzer 1401 can obtain the device API from the network registration service. Other devices, such as universal plug and play (“UP&P”) or OSGI conduct messaging somewhat differently, but the structure and registration service can be utilized in a similar manner. Device analyzer can further analyze the information obtained to determine what the device is and how it is used.

Template creator 1403 provides for determining the semantics of using a device in accordance with the grammar determined by device analyzer 1401. Unlike device analyzer 1401, however, template creator 1403 currently requires a human actor to record the structure and functionality, for example, of a web site (such as the location of product descriptions, prices photos and other product data and how the site's shopping card and search applications work). Template creator 1403 uses this information to create a template useable by the spider tool 1405.

Spider tool 1405 provides for gathering information from a web site, such as product, manufacturer and vendor data, for addition to the matching-system information. Spider tool 1405 is further capable of automatically filling out and submitting forms to get data or make a purchase (without human intervention), of communicating with a data structure and of communicating with wish fulfillment monitor 1201 (FIG. 12).

Of the remaining product-vendor portrayer elements, product analyzer 1407 provides for automatically analyzing a set of products and returning their cognitive aspects, and producing product portraits therefrom. Product analyzer 1407 uses a variety of lexical analysis techniques such as latent semantic indexing. Vendor analyzer 1409 operates in a similar manner as with product analyzer to produce vendor portraits. However, while product analyzer 1407 typically operates on single documents (e.g. fact sheets), vendor analyzer 1409 typically operates on a plurality of documents, such as a vendor web site.

As was already discussed, product and/or vendor information can also be determined interactively from one or more vender-users or others in a similar manner as with consumer information. One or more of the portrayer engine 309 elements (see FIGS. 6-8) can be again utilized or one or more product/vendor specific elements can also be used in accordance with a particular application or implementation considerations (e.g. where separate wish and product portrayer servers are utilized, such as with the separate implementation example of FIG. 1).

Thus, for example, product-vendor portrayer 131 might also include product, vendor or the depicted combined cognitive basis engine 1411 for determining a cognitive basis according to which a vendor or other person (e.g. having or representing a particular age, gender, culture, etc.) might describe himself, another or a product; separate product and vendor cognitive basis engines might also be utilized (not shown). (Cognitive bases might also be broadly viewed as including such a product/vender attribute in appropriate instances.) Similarly, product-vendor portrayer 131 can comprise combined (in whole or part) or the depicted separate product portrait, objectives and facts/parameters engines 1413a-c and vendor portrait, objectives and facts engines 1415c. (One or more separately implemented ones of the behavioral portrayer 602 elements of FIG. 6 might also be utilized, as already noted.)

Product-vendor portrayer elements 1411-1415c are also operable in a similar manner as the above-noted (consumer) portrayer engine 309 of FIGS. 6-8. For example, product/vendor cognitive basis engine 1411 can provide suitable product/vendor interfaces for determining a product/vendor cognitive basis (or certain cognitive basis aspects can be determined from available information, via elements 1410-1415 or by inference from the server, product or vendor location or other discernable information, such as was already discussed).

Product or vendor portrait engines 1413a, 1415a can further include a translater, transporter, translation maps or other suitable elements for providing suitable profiling interfaces consistent with the corresponding determined cognitive bases, and communicating assignable weights to form product/vendor profiles (which can be further analyzed by product vendor analyzers 1407, 1409 as with (consumer) portrait analyzer 613 of FIG. 7a (e.g. to form product/vendor portraits). Product or vendor objectives engines 1413b, 1415b can similarly provide interface or communication mechanisms for communicating product/vendor objectives. Product facts/parameter engine 1413c can similarly provide an interface and communication mechanism for receiving product facts or parameters (or suggested facts/parameters for consideration by matching-system administrators), and vendor objectives can operate similarly with regard to vendor facts (which can include factual or parameterized products provided by a vendor), and so on.

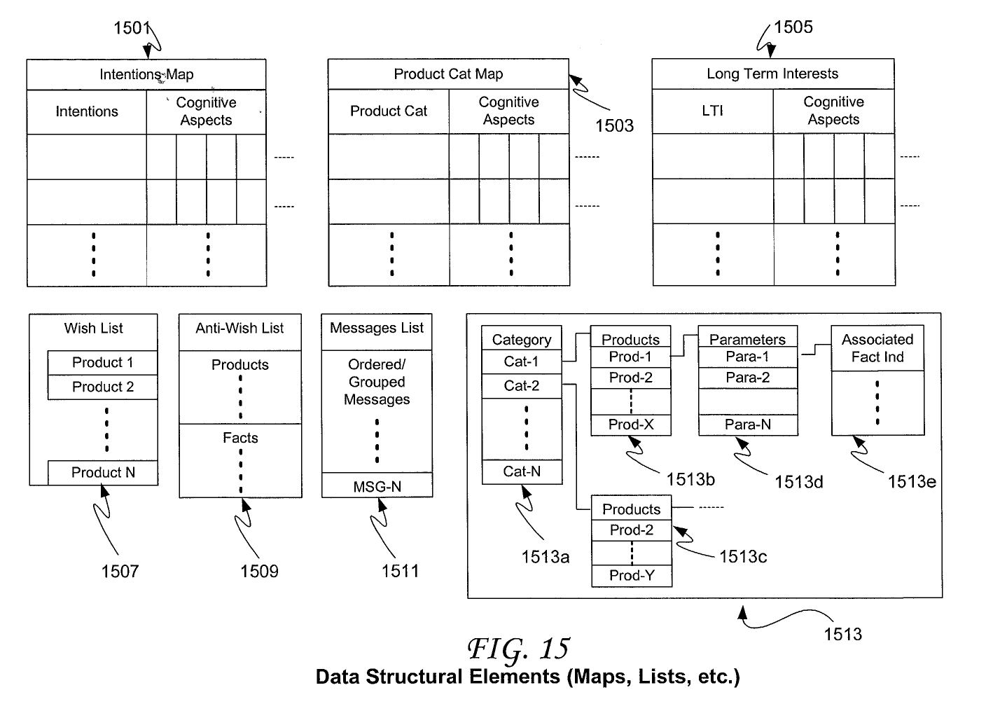

FIG. 15 illustrates examples of the above-mentioned data structures that are created or maintained by matching-system elements of the Personal Genie matching-system implementation. As shown, intentions map 1501 product categories map 1503 and long-term interests map 1505 indicate (consumer, product or vendor) intentions, product (or vendor) categories and (consumer, product or vendor) long-term interests respectively according to combinations of cognitive aspect weights for each cognitive aspect of each cognitive basis. (Product categories can, for example, include entertainment, televisions, music, etc.) Wish list 1507 and anti-wish list 1509 further indicate products, facts or other information (e.g. vendors, timing, etc.—see above) corresponding to consumer wish inclusions and exclusions respectively.

Of the remaining data structures depicted in FIG. 15, messages list 1511 includes a preferably time, importance, type, transaction or otherwise ordered, linked or grouped list of consumer messages (e.g. to/for a consumer or group). Finally, the categories structure 1513 example includes a product/vendor category field 1513a including categories (1-N). Each category having associated products is also coupled to a corresponding products field (e.g. 1513b, 1513c) that includes one or more associated products (1-X, 1-Y) within that category. Each product having associated parameters is further coupled to a corresponding parameters field (e.g. 1513d) including such parameters. Each parameters field having associated facts (e.g. a product, vendor or consumer fact) is still further coupled to a corresponding fact indicator field. (While the viability of all consumer facts might, for example, be considered in each matching, associating a fact indicator with particular products/vendors enables only pertinent facts to be considered, as already noted.)

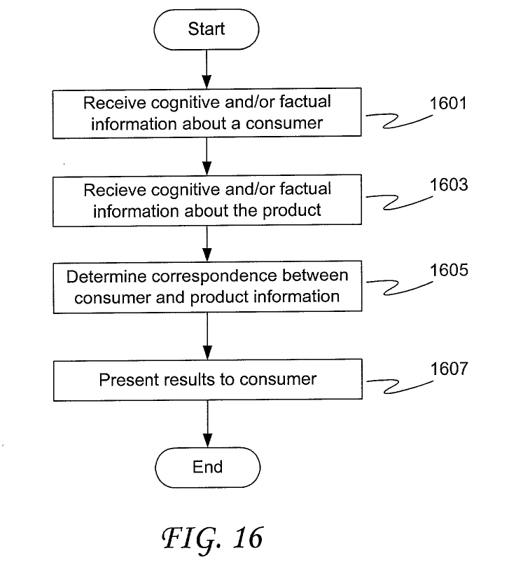

Beginning with FIG. 16, methods according to embodiments of the invention will not be discussed in greater detail.

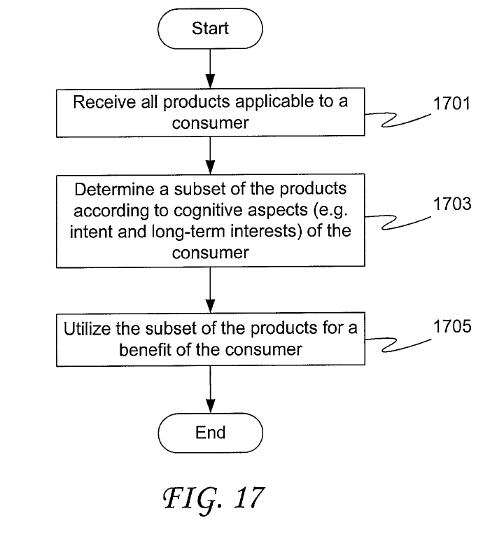

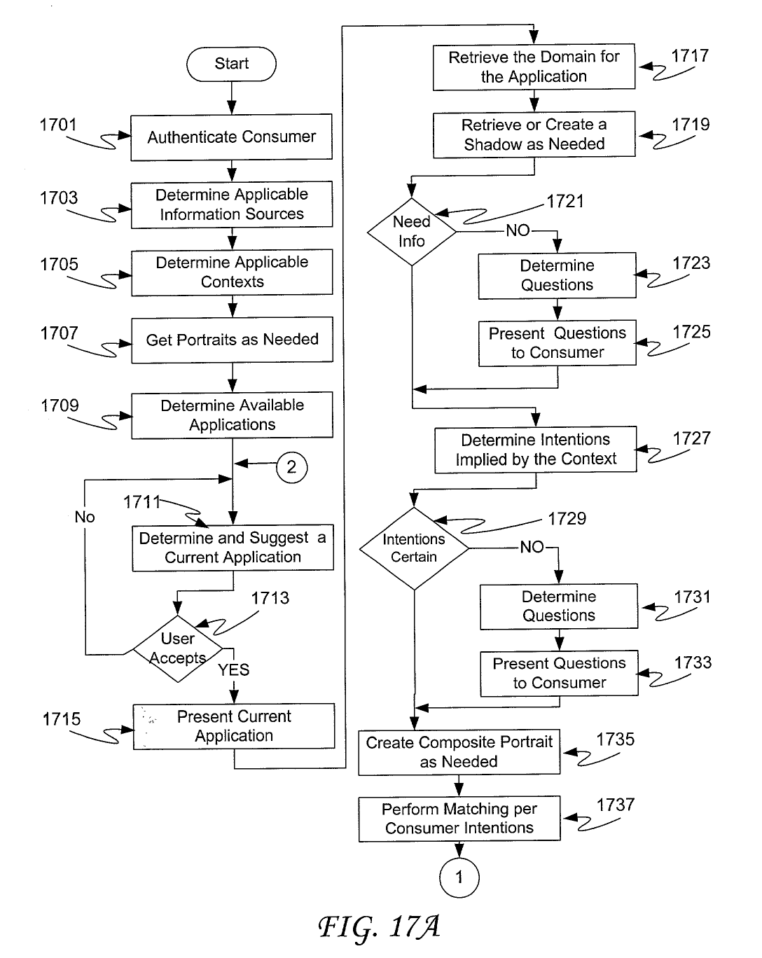

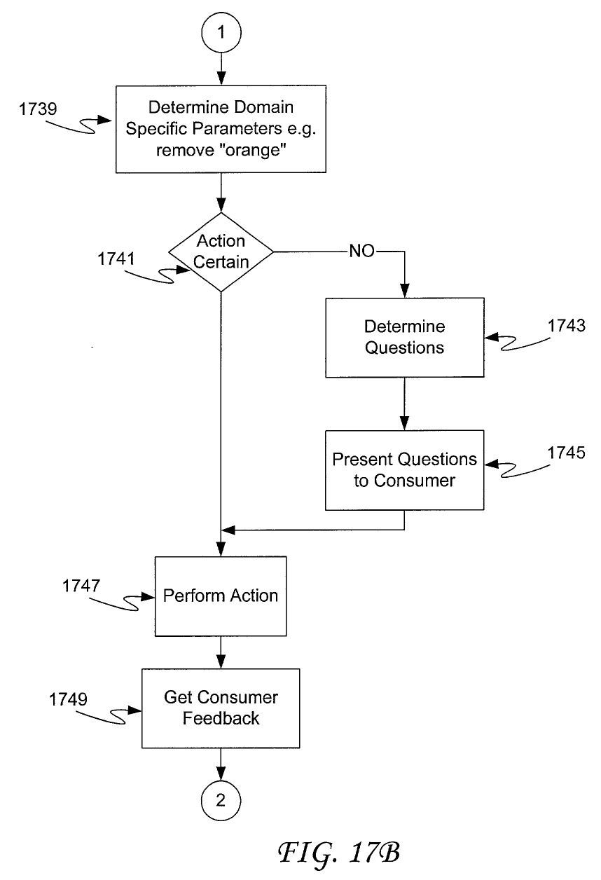

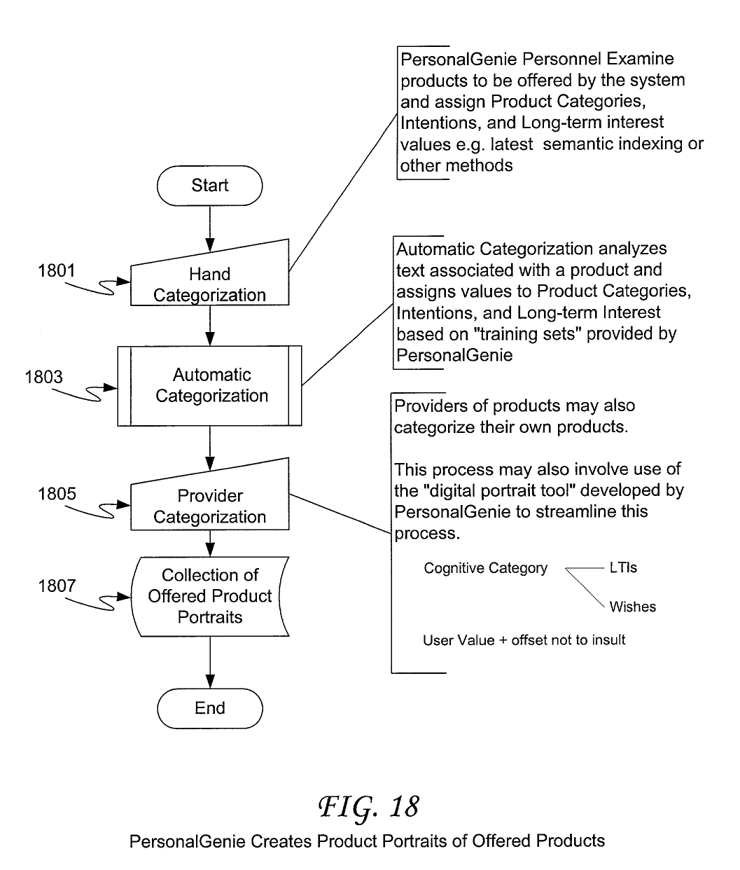

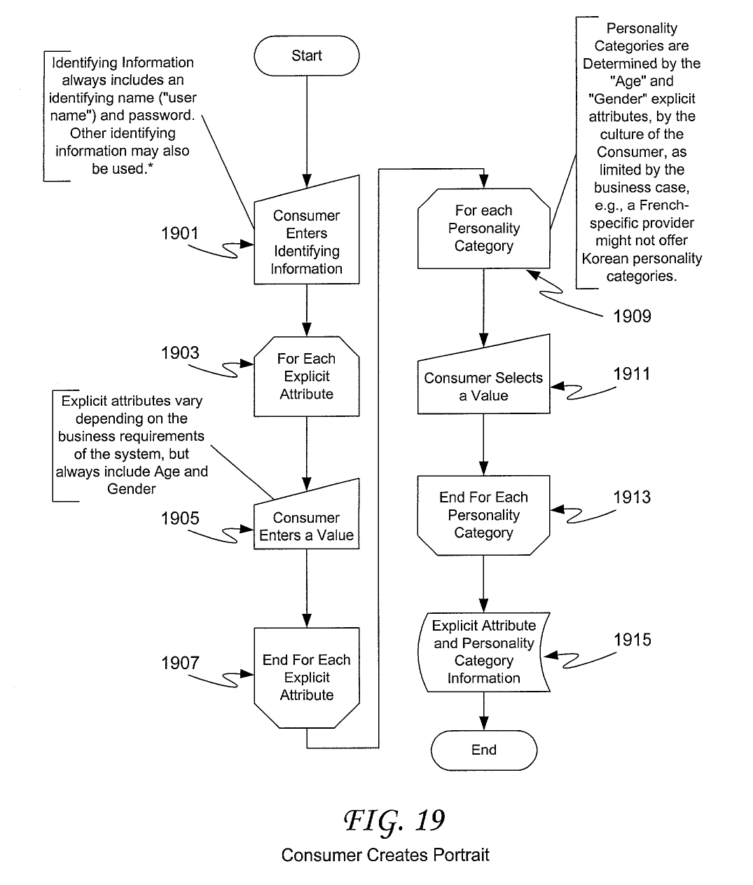

FIG. 16 illustrates how a method for matching consumers and products or vendors according to an embodiment of the invention begins in step 1601 with receiving applicable cognitive (e.g. cognitive basis, personality and objective) consumer information and factual consumer information about a consumer. (As noted above, the consumer information can further relate to an other consumer, group of consumers, thing, pet, place, etc.) Method 1600 further includes receiving applicable cognitive and applicable factual product (or vendor) information about a product in step 1603, determining one or more correspondences between the consumer and product information in step 1605, and presenting one or more resulting corresponding products in step 1607. A matching process according to an embodiment of the invention can also be broadly viewed as including receiving products (or vendors) applicable to a consumer, determining a subset of the products according to cognitive aspects (e.g. intent and long term interests) of the consumer, and utilizing the subset for a benefit of the consumer, as given by steps 1701-1705 of FIG. 17.

FIG. 18 illustrates a detailed method for matching consumers and products or vendors according to an embodiment of the invention. As shown, a consumer is authenticated by a wish server in step 1801. The wish server determines one or more applicable information sources in step 1803, determines one or more applicable contexts in step 1805, retrieves one or more applicable portraits in step 1807 (e.g. relating to a consumer and one or more others) and determines available applications (i.e. suitable program code as already noted) in step 1809. In step 1811, the wish server determines and suggests to a consumer a current application via an available consumer device (e.g. inferable based on the received or determined information). If the consumer rejects the suggested application (step 1813), then the matching system returns to step 1811; otherwise, the matching system presents the suggested current application (step 1815).

The matching system further retrieves a domain for the current application in step 1817 and retrieves an existing shadow, if one exists, or creates a new shadow in step 1819. If, in step 1821, more information is needed that is appropriately ascertainable from the consumer for inferring consumer intentions, then the matching system determines one or more applicable questions for determining the information in step 1823 and presents the questions to the consumer in step 1825 (also receiving the answers or information, which is not explicitly shown). The matching system further determines consumer intentions implied by the context in step 1827 and, continues to step 1835 if the intentions are sufficiently certain in step 1829, or determines and presents to the consumer one or more appropriate questions in steps 1831-1833 (again including receiving consumer answers as discussed above).

The matching system further creates a composite portrait (if more than one portrait was earlier retrieved) in step 1835 and performs product/vendor matching as applicable to the above-determined consumer intentions in step 1837. In step 1839, the matching system determines domain-specific parameters, such as including or removing matches referring to a particular color or other product attribute. If a sufficiently certain presentation action is indicated for the match in 1741, then the matching system performs the action in step 1847 and receives appropriate consumer feedback (if any) in step 1849; otherwise, the matching system determines questions pertaining to determining an action in step 1843 and presents the questions to the consumer (including receiving consumer answers) in step 1845 before proceeding to step 1847.

FIG. 19 illustrates a method for creating the aforementioned “base” consumer profile according to an embodiment of the invention. As was already noted, a consumer profile is creatable by a consumer-user (or another) of any suitable consumer device accessible, at least intermittently during information transfer, to a matching-system. The matching-system can further provide interfaces to a consumer device, enabling consumer information value entry or selection and communication of such values to the matching system, or other suitable consumer information intercommunication mechanisms can also be utilized (see above). For clarity sake, however, method 1900 is depicted from the perspective of a consumer-device consumer-user, and corresponding matching-system operations are not shown.

In step 1901 of FIG. 19, a consumer enters (via one or more suitable consumer devices) consumer identifying information (which, in the Personal Genie implementation, includes at least a consumer's name.) In steps 1903-1907, the consumer enters explicit (i.e. factual) values for each of a set of explicit attributes. Explicit attribute values can vary for different business or other application requirements, and include, for a cognitive-basis-variable matching-system, cognitive basis values not otherwise sufficiently conclusively determined by the matching-system, such as age, gender, etc. (see above). In steps 1909-1913, the consumer enters a set of cognitive profiling aspects (e.g. personality), which aspects can be determined in accordance the cognitive basis values, and other suitable criteria (e.g. further determined cognitive basis values, business/application criteria, etc.).

Additional consumer profiles can also be created, for example, according of FIGS. 20 and 21 respectively. Beginning with FIG. 20, a consumer can create an additional profile/portrait by selecting a type of portrait appropriate to a particular object, such as a house, automobile, entertainment, etc. (Note that an available set of selectable or otherwise determinable portrait types can be limited by a specific business/application and can further be pre-selectable by a particular matching-system embodiment.)

The preceding description is provided to enable a person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein. The embodiments described herein are not intended to be exhaustive or limiting. The present invention is limited only by the following claims.

What is claimed is:

1. A method, comprising:
inputting, by a user, consumer information into a user interface, the consumer information consisting of a set of data describing a consumer specified by the user;
translating, by a computer system, the consumer information into a digital portrait;
determining, by a computer system, usage patterns and product purchase patterns of the user over a predetermined time period; and
updating, by a computer system, the digital portrait based upon the determined usage patterns and product purchase patterns.

2. The method of claim 1, wherein the consumer information comprises personality indicators corresponding to personality aspects of the consumer.

3. The method of claim 2, wherein the personality aspects include predetermined personality aspects to which weights are assigned that correspond to the inputting.

4. The method of claim 1, wherein the user interface comprises a plurality of personality selector means with which the user can assign weights to predetermined personality aspects according to the user's perception of the consumer's personality.

5. The method of claim 4, wherein the user interface further comprises a personality profiler means for presenting to the user a representation of one or more of the personality aspects of the consumer according to the corresponding weights currently assigned by the user to the aspects.

6. The method of claim 5, wherein the representation comprises at least one of a two dimensional graphic and a three dimensional graphic including graphical elements that are accentuated or subdued according to the corresponding weights currently assigned by the user to the aspects.

7. The method of claim 1, wherein at least one of the personality aspects and the personality selector means corresponds to at least one of an ethnicity, culture and age of the user.

8. The method of claim 1, wherein at least one of the personality aspects and the personality selector means corresponds to at least one of an ethnicity, culture and age of the consumer.

9. The method of claim 1, wherein the translating includes applying a mathematical algorithm to create a set of digital values corresponding to personality aspects of the consumer.

10. A system, comprising:
a networked device means including a user interface that is capable of accepting consumer information from a user, the consumer information including a set of data describing a consumer specified by the user;
a consumer portrait tool means, coupled to the networked device means via an interconnected network, for translating the consumer information into a mathematical form;
a consumer portrait analyzer means, coupled to the consumer portrait tool means, for creating a digital consumer portrait from the mathematical form; and
a usage monitor means, coupled to the consumer portrait analyzer means, for determining usage patterns and product purchase patterns of the user over a predetermined time period, and for providing the determined usage patterns and product purchase patterns to the consumer portrait analyzer for updating the digital consumer portrait.

11. The system of claim 10, wherein the consumer information includes weighted personality aspects of the consumer.

12. The system of claim 10, further comprising a storage means for storing a plurality of predetermined digital consumer portraits to form a portrait gallery controlled by the user.

13. The system of claim 10, further comprising a storage means for storing a pointer to specific components of a digital consumer portrait to form a silhouette.

14. A method, comprising:
obtaining, via an interconnected network, user intent data from a user;
obtaining a consumer portrait, the consumer portrait representing a set of data describing a consumer specified by the user;
obtaining at least one product portrait, each product portrait representing a set of data describing a product and a vendor associated with the product;
determining at least one matching product, the matching product having a product portrait which substantially matches the consumer portrait and the user intent data; and
identifying, via the interconnected network, the at least one matching product to the user.

15. The method of claim 14, further comprising:
sending, to the vendor associated with the at least one matching product, a purchase transaction for the at least one matching product, the purchase transaction including at least a portion of the set of data describing the consumer specified by the user;
monitoring a status of the purchase transaction; and
providing the status of the purchase transaction to the user.

16. A method, comprising:
obtaining user purchase request criteria from a user;
obtaining a consumer portrait, the consumer portrait representing a set of data describing a consumer specified by the user;
obtaining at least one product portrait, each product portrait representing a set of data describing a product and a vendor associated with the product;
determining at least one matching product, the matching product having a product portrait which substantially matches the consumer portrait and the user purchase request criteria;
sending, to the vendor associated with the at least one matching product, a purchase transaction for the at least one matching product;
monitoring a status of the purchase transaction; and
providing the status of the purchase transaction to the user.

17. A system, comprising:
a networked device means including a user interface means capable of accepting, from a user, a purchase request criteria;
storage media means, coupled to the networked device via an interconnected network, for storing the user purchase request criteria, and for storing a predetermined digital consumer portrait and a predetermined digital product portrait;
purchasing agent tool means, coupled to the storage media, for generating a purchase transaction, the purchase transaction directing a vendor associated with the digital vendor portrait to provide a product associated with the digital product portrait to a consumer associated with the digital consumer portrait; and
wish fulfillment monitor means, coupled to the purchasing agent tool means and the networked device means, for monitoring the purchase transaction and providing to the user, via the user interface means, a status of the purchase transaction.

18. A method, comprising;
storing a plurality of product descriptions on a computer system, each product description corresponding to a product provided by a vendor;
storing a plurality of consumer descriptions on a computer system;
receiving, by a computer system, user intent data and a specific one of the plurality of consumer descriptions; and
determining, by a computer system, at least one said product with a product description which substantially matches the user intent data and the specific one of the plurality of consumer descriptions.
